(19) United States
(12) Patent Application Publication
(10) Pub. No.: US 2014/0254412 A1
(43) Pub. Date: Sep. 11, 2014

(54) METHOD AND NETWORK NODE IN A RADIO COMMUNICATION SYSTEM

(71) Applicant: Telefonaktiebolaget L M Ericsson (publ), Stockholm (SE)

(72) Inventor: Iana Siomina, Solna (SE)

(21) Appl. No.: 14/234,103

(22) PCT Filed: Oct. 9, 2013
(86) PCT No.: PCT/SE2013/051190

§ 371 Date: Jan. 21, 2014

Related U.S. Application Data
(60) Provisional application No. 61/753,456, filed on Jan. 17, 2013.

(51) Int. Cl. H04W 4/02; H04W 24/08

(52) U.S. Cl. CPC H04W 4/02; H04W 24/08
USPC 370/252

(57) ABSTRACT

A wireless device and a method therein for performing a positioning measurement are disclosed. The wireless device obtains uplink/downlink, “UL/DL”, subframe configuration information relating to a second radio network node neighboring to a first radio network node. The wireless device performs the positioning measurement while taking the obtained UL/DL subframe configuration information into account. Moreover, a first radio network node and a method therein for configuring positioning reference signals, positioning subframes and/or an UL/DL subframe configuration are disclosed. The first radio network node configures positioning reference signals, positioning subframes and/or the UL/DL subframe configuration in a non-ambiguous set of downlink subframes. Furthermore, a positioning node and a method therein for building positioning assistance data to be used by a wireless device, wherein each radio network node of the set of radio network nodes is associated with a respective UL/DL subframe configuration information.

### TECHNICAL FIELD

Embodiments herein relate to radio communication systems, such as telecommunication systems. Some embodiments may relate to methods for enhancing downlink positioning measurements in networks with multiple uplink/downlink subframe configurations.

In particular, a wireless device and a method therein for performing a positioning measurement are disclosed. Moreover, a first radio network node and a method therein for configuring positioning reference signals, positioning subframes and/or an uplink/downlink subframe configuration are disclosed. Furthermore, a positioning node and a method therein for building positioning assistance data to be used by a wireless device are disclosed.

### BACKGROUND

Communication devices such as wireless devices may be also known as e.g. user equipments (UEs), mobile terminals, wireless terminals and/or mobile stations. A wireless device is enabled to communicate wirelessly in a cellular communications network, wireless communications system, or radio communications system, sometimes also referred to as a cellular radio system, cellular network or cellular communications system. The communication may be performed e.g. between two wireless devices, between a wireless device and a regular telephone and/or between a wireless device and a server via a Radio Access Network (RAN) and possibly one or more core networks, comprised within the cellular communications network. The wireless device may further be referred to as a mobile telephone, cellular telephone, laptop, Personal Digital Assistant (PDA), tablet computer, just to mention some further examples. The wireless device may be, for example, portable, pocket-storable, hand-held, computer-comprised, or vehicle-mounted mobile device, enabled to communicate voice and/or data, via the RAN, with another entity, such as another wireless device or a server.

The cellular communications network covers a geographical area which is divided into cell areas, wherein each cell area is served by at least one base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. Cells may overlap so that several cells cover the same geographical area. By the base station serving a cell is meant that the radio coverage is provided such that one or more wireless devices located in the geographical area where the radio coverage is provided may be served by the base station. One base station may serve one or several cells. Further, each base station may support one or several communication technologies. The base stations communicate over the air interface operating on radio frequencies with the wireless device within range of the base stations.

An uplink (UL) relates to radio transmissions from the wireless device to the radio base station and a downlink (DL) relates to radio transmissions from the radio base station to the wireless device.

### Duplex Configuration

A duplex communication system is a point-to-point system composed of two connected parties or devices that can communicate with one another in both directions.

A half-duplex (HDX) system provides communication in both directions, but only one direction at a time, not simultaneously.

A full-duplex (FDX), or sometimes double-duplex system, allows communication in both directions, and, unlike half-duplex, allows this to happen simultaneously.

Time-division duplexing (TDD) is the application of time-division multiplexing to separate outward and return signals, i.e. operating over a half-duplex communication link.

Frequency-division duplexing (FDD) means that the transmitter and receiver operate at different carrier frequencies, typically separated by a frequency offset.

Long Term Evolution (LTE) specification enables FDD and TDD operation modes. Additionally, half duplex operation is also specified, which is essentially FDD operation mode but with transmission and receptions not occurring simultaneously as in TDD. Half duplex mode has advantages with some frequency arrangements where the duplex filter may be unreasonable, resulting in high cost and/or high power consumption. Since carrier frequency number, a so called Evolved Universal Terrestrial Radio Access (EUTRA) Absolute Radio Frequency Channel Number (EARFCN), is unique, by knowing it, it is possible to determine the frequency band, which is either FDD or TDD. However, it may be more difficult to find difference between full duplex FDD and half-duplex FDD (HD FDD) without explicit information since same FDD band can be used as full FDD or HD FDD.

In Third Generation Partnership Project (3GPP), two radio frame structure types are currently supported: Type 1 (applicable to FDD) and Type 2 (applicable to TDD).

### FDD

In FIG. 1, frame structure type 1 is illustrated. The frame structure type 1 is applicable to both full duplex and HD FDD.

For FDD, 10 subframes are available for downlink transmission and 10 subframes are available for uplink transmissions in each 10 ms interval. Each 10 ms interval may be referred to as a radio frame, T_{f}. Each subframe includes two slots Tₛₗₒₜ, each being 0.5 ms long. In this figure, the slots are numbered from 0 to 19. Uplink and downlink transmissions are separated in the frequency domain. In HD FDD operation, the User Equipment (UE) cannot transmit and receive at the same time while there are no such restrictions in full-duplex FDD. Tₛ is the sample interval in the time domain, e.g. approximately 0.5 microseconds.

There is no need for a guard period for full-duplex FDD. See FIG. 2 below for a description of guard period. For HD FDD operation, the guard period is created by the UE by not receiving the last part of a downlink subframe immediately preceding an uplink subframe from the same UE.

### TDD

In FIG. 2, frame structure type 2 is illustrated. A Guard Period (GP) is surrounded by Downlink Pilot Time Slot (DwPTS), and Uplink Pilot Time Slot (UpPTS). DwPTS is like a regular but shortened downlink subframe. In FIG. 2, the subframes have been numbered from 0 to 9. The same or like reference numerals as in FIG. 1 have been reused when applicable.

### UL/DL TDD Configurations

The table below shows UL/DL TDD configurations defined so far in 3GPP, where, for each subframe in a radio frame, “D” denotes the subframe is reserved for downlink transmissions, “U” denotes the subframe is reserved for uplink transmissions and “S” denotes a special subframe with the three fields DwPTS, GP (TDD guard period), and UpPTS. Choosing a specific UL/DL configuration may be determined e.g. by traffic demand in DL and/or UL and network capacity in DL and/or UL.

| Uplink- | Downlink-to- | | | | | | | | | | | |
|---|---|---|---|---|---|---|---|---|---|---|---|---|
| downlink | Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Subframes 0 and 5 and DwPTS are always reserved for downlink transmission. UpPTS and the subframe immediately following the special subframe are always reserved for uplink transmission.

The length of DwPTS and UpPTS depends on the combination of DL and UL cyclic prefix lengths and on the special subframe configuration (10 pre-defined special subframe configurations are defined in TS 36.211). Typically, DwPTS is longer than UpPTS.

In case multiple cells are aggregated, the UE may assume that the guard period of the special subframe in the different cells have an overlap of at least 1456*Tₛ, where Tₛ is the sample interval in the time domain as mentioned above.

### UL/DL Subframe Configurations in Different Cells

TDD networks are synchronous networks, with aligned radio frame boundaries. When positioning requirements were defined, it has been assumed that the same UL/DL subframe configuration is used in all cells, and the UE indeed knows the UL/DL configuration in the serving cell.

However, different UL/DL configurations may also be configured in neighbouring cells. The UE may obtain this information via dedicated signalling in a measurement configuration object for intra- or inter-frequency cells or by reading System Information Block 3 (SIB3) and SIB5. However, the information obtained in this way is very limited. The SIB3 and/or SIB5 may carry a NeighCellConfig Information Element (IE) as described below on a Physical Downlink Shared Channel (PDSCH) during synchronization, between UE and eNodeB. The periodicity is specified by the periodically transmitted SIB1 which is transmitted every 40 ms.

### NeighCellConfig

The IE NeighCellConfig is used to provide the information related to Multicast-Broadcast Single-Frequency Network (MBSFN) and TDD UL/DL configuration of neighbouring cells.

NeighCellConfig information element

| - - | ASN1START | |
|---|---|---|
| NeighCellConfig ::= | | BIT STRING (SIZE (2)) |
| -- | ASN1STOP | |

NeighCellConfig field descriptions
NeighCellConfig
Provides information related to MBSFN and TDD UL/DL
configuration of neighbour cells, or neighbouring
cells, of this frequency
00: Not all neighbouring cells have the same
MBSFN subframe allocation as the serving cell
on this frequency, if configured, and as the PCell
otherwise
10: The MBSFN subframe allocations of all
neighbouring cells are identical to or
subsets of that in the serving cell on
this frequency, if configured, and of that in
the PCell otherwise
01: No MBSFN subframes are present in all
neighbouring cells
11: Different UL/DL allocation in neighbouring
cells for TDD compared to the serving cell
on this frequency, if configured, and compared
to the PCell otherwise
For TDD, 00, 10 and 01 are only used for same UL/DL
allocation in neighbouring cells compared
to the serving cell on this frequency, if configured,
and compared to the PCell otherwise.

Thus, the UE may only know whether there is at least one cell with a different UL/DL subframe configuration on a frequency or all cells have the same UL/DL subframe configuration.

### Positioning Architecture in LTE

Three key network elements in an LTE positioning architecture are the Location Service (LCS) Client, the LCS target and the LCS Server, such as SLP in FIG. 3. SLP stands for Secure User Plane Location, SUPL, Location Platform (SLP). The LCS Server is a physical or logical entity managing positioning for a LCS target device, such as a UE in FIG. 3, by collecting measurements and other location information, assisting the terminal in measurements when necessary, and estimating the LCS target location. A LCS Client is a software and/or hardware entity that interacts with a LCS Server for the purpose of obtaining location information for one or more LCS targets, i.e. the entities being positioned. LCS Clients may also reside in the LCS targets themselves. An LCS Client sends a request to LCS Server to obtain location information, and LCS Server processes and serves the received requests and sends the positioning result and optionally a velocity estimate to the LCS Client. A positioning request may be originated from the UE or a network node or external client.

Position calculation may be conducted, for example, by a positioning server, e.g. Evolved Serving Mobile Location Center (Evolved SMLC or E-SMLC) or SLP in LTE, or a UE. The former approach corresponds to the UE-assisted positioning mode, whilst the latter corresponds to the UE-based positioning mode.

Two positioning protocols operating via the radio network exist in LTE, LTE Positioning Protocol (LPP) and LPPa. The LPP is a point-to-point protocol between a LCS Server and a LCS target device, used in order to position the target device. LPP can be used both in the user and control plane, and multiple LPP procedures are allowed in series and/or in parallel thereby reducing latency. LPPa is a protocol between evolved Node B (eNodeB) and LCS Server specified only for control-plane positioning procedures, although it still can assist user-plane positioning by querying eNodeBs for information and eNodeB measurements. SUPL protocol is used as a transport for LPP in the user plane. LPP has also a possibility to convey LPP extension messages inside LPP messages, e.g. currently Open Mobile Alliance (OMA) LPP extensions are being specified (LPPe) to allow e.g. for operator-specific assistance data or assistance data that cannot be provided with LPP or to support other position reporting formats or new positioning methods.

A high-level architecture, as it is currently standardized in LTE, is illustrated in FIG. 3, where the LCS target is a terminal, and the LCS Server is an E-SMLC or an SLP. In the figure, the control plane positioning protocols with E-SMLC as the terminating point are shown in blue, and the user plane positioning protocol is shown in red. SLP may comprise two components, SUPL Positioning Center (SPC) and SUPL Location Center (SLC), which may also reside in different nodes. In an example implementation, SPC has a proprietary interface with E-SMLC, and Llp interface with SLC, and the SLC part of SLP communicates with a Packet Data Network (PDN) Gateway (P-GW) and External LCS Client. A core network, including the E-SMLC may further comprise a Gateway Mobile Location Centre (GMLC), which comprises functionality required to support Location-based Services (LBS), and a Mobility Management Entity (MME).

Additional positioning architecture elements may also be deployed to further enhance performance of specific positioning methods. For example, deploying radio beacons is a cost-efficient solution which may significantly improve positioning performance indoors and also outdoors by allowing more accurate positioning, for example, with proximity location techniques.

### Observed Time Difference of Arrival (OTDOA) Positioning

The OTDOA positioning method makes use of the measured timing of downlink signals received from multiple eNodeBs at the UE. The UE measures the timing of the received signals using assistance data received from the LCS server, and the resulting measurements are used to locate the UE in relation to the neighbouring eNodeBs.

With OTDOA, a UE measures the timing differences for downlink reference signals received from multiple distinct locations. For each (measured) neighbouring cell, the UE measures Reference Signal Time Difference (RSTD) which is the relative timing difference between neighbouring cell and the reference cell.

The RSTD measurement may be intra-frequency, inter-frequency or carrier aggregation. In case of intra-frequency RSTD, all cells are on the same carrier as that of the serving cell. Inter-frequency RSTD measurements involve measurements on at least one cell that belongs to a frequency/carrier which is different than that of the serving/primary cell. In case of carrier aggregation the RSTD is measured on primary cell or secondary cell (PCell, SCell) and may also be measured on both PCell and SCell, e.g. reference and neighbouring cells on PCell and SCell respectively.

The UE position estimate is then found as the intersection of hyperbolas corresponding to the measured RSTDs. At least three measurements from geographically dispersed base stations with a good geometry are needed to solve for two coordinates of the UE and the receiver clock bias. In order to solve for position, precise knowledge of the transmitter locations and transmit timing offset is needed.

To enable positioning in LTE and facilitate positioning measurements of a proper quality and for a sufficient number of distinct locations, new physical signals dedicated for positioning, Positioning Reference Signals, or PRS [3GPP TS 36.211], have been introduced and low-interference positioning subframes have been specified in 3GPP.

PRS are transmitted from one antenna port (e.g. an antenna port called R6) according to a pre-defined pattern as specified in 3GPP TS 36.211. A frequency shift, which is a function of Physical Cell Identity (PCI), may be applied to the specified PRS patterns to generate orthogonal patterns and modelling the effective frequency reuse of six, which makes it possible to significantly reduce neighbour cell interference on the measured PRS and thus improve positioning measurements. Even though PRS have been specifically designed for positioning measurements and in general are characterized by better signal quality than other reference signals, the standard does not mandate using PRS. Other reference signals, e.g. Cell-specific Reference Signals (CRS) could in principle also be used for positioning measurements.

PRS are transmitted in pre-defined positioning subframes grouped by several downlink consecutive subframes (N_{PRS}), i.e. one positioning occasion as shown in FIG. 4. Positioning occasions occur periodically with a certain periodicity of N subframes, i.e. the time interval between two positioning occasions. The standardized periods N are 160, 320, 640, and 1280 ms, and the number of consecutive downlink subframes may be N_{PRS}=1, 2, 4, or 6 as specified in 3GPP TS 36.211. N_{PRS} is the parameter configured by higher layers. Maximum N_{PRS}, i.e., 6, is typically configured for the smallest bandwidth (1.4 MHz), whilst a smaller N_{PRS} may be configured for a larger PRS bandwidth.

Note that for the same N_{PRS}, in TDD, the set of consecutive downlink subframes may be different in different UL/DL subframe configurations (i.e., depending on the location of UL subframes and special subframes).

FIG. 4 shows positioning subframe allocation in time for a single cell. FIG. 4 shows a number of periods of N subframes, each comprising a positioning occasion of 6 consecutive subframes, i.e. N_{PRS}=6.

### OTDOA Assistance Information

To facilitate UE measurements, the network transmits assistance data to the UE (via LPP or LPPe), which includes, among the others, reference cell information, neighbour cell list containing PCIs of neighbouring cells, PRS configuration index (describing PRS periodicity and PRS subframe offset with respect to System Frame Number (SFN)=0), the number of consecutive downlink subframes, PRS transmission bandwidth, frequency, etc. The PRS information for reference and each neighbouring cell transmitted via LPP is as follows:

```
-- ASN1START
PRS-Info ::= SEQUENCE {
  prs-Bandwidth ENUMERATED { n6, n15, n25, n50, n75,
n100, . . . },
  prs-ConfigurationIndex INTEGER (0 . . 4095),
  numDL-Frames ENUMERATED {sf-1, sf-2, sf-4, sf-6,
. . . },
. . . ,
prs-MutingInfo-r9 CHOICE {
```

| po2-r9 | BIT STRING (SIZE(2)), | | |
|---|---|---|---|
| po4-r9 | BIT STRING (SIZE(4)), | | |
| po8-r9 | BIT STRING (SIZE(8)), | | |
| po16-r9 | BIT STRING (SIZE(16)), | | |
| . . . | | | |
| } | | OPTIONAL | - |

- Need OP
}
-- ASN1STOP

Some wireless communication networks use non-full duplex mode, such as TDD or HD-FDD.

If UL/DL subframe configuration is uncertain at the UE, performing RSTD positioning measurements in TDD cells and achieving good positioning performance becomes challenging.

### SUMMARY

An object is to improve positioning performance of a telecommunication system.

According to an aspect, the object is achieved by a method, performed by a wireless device, for performing a positioning measurement in a wireless communication network comprising a first radio network node and a second radio network node neighboring to the first radio network node, which is serving the wireless device. The wireless device obtains uplink/downlink, “UL/DL”, subframe configuration information relating to the second radio network node. The wireless device performs the positioning measurement while taking the obtained UL/DL subframe configuration information into account.

According to another aspect, the object is achieved by a wireless device configured to perform a positioning measurement in a wireless communication network comprising a first radio network node and a second radio network node neighboring to the first radio network node, which is serving the wireless device. The wireless device comprises a processing circuit configured to obtain UL/DL subframe configuration information relating to the second radio network node, and to perform the positioning measurement while taking the obtained UL/DL subframe configuration into account.

According to a further aspect, the object is achieved by a method, performed by a first radio network node, for configuring positioning reference signals, positioning subframes and/or an UL/DL subframe configuration, wherein the first radio network node uses multiple UL/DL subframe configurations in a cell of the first radio network node. The first radio network node configures positioning reference signals, positioning subframes and/or the UL/DL subframe configuration in a non-ambiguous set of downlink subframes.

According to a still further aspect, the object is achieved by a first radio network node configured to configure positioning reference signals, positioning subframes and/or an UL/DL subframe configuration. The first radio network node uses multiple UL/DL subframe configurations in a cell of the first radio network node. The first radio network node comprises a processing circuit configured to configure positioning reference signals, positioning subframes and/or UL/DL subframe configuration in a non-ambiguous set of subframes.

According to a yet further aspect, the object is achieved by a method, performed by a positioning node, for building positioning assistance data to be used by a wireless device when performing positioning measurements on a set of radio network nodes, wherein each radio network node of the set of radio network nodes is associated with a respective UL/DL subframe configuration information, wherein at least one respective UL/DL subframe configuration information is different from at least one other respective UL/DL subframe configuration information. The positioning node generates the positioning assistance data while taking at least one respective UL/DL subframe configuration information into account, thereby building the positioning assistance data. The positioning node sends the positioning assistance data to the wireless device.

According to yet another aspect, the object is achieved by a positioning node configured to build positioning assistance data to be used by a wireless device when performing positioning measurements on a set of radio network nodes. Each radio network node of the set of radio network node is associated with a respective UL/DL subframe configuration information. At least one respective UL/DL subframe configuration information is different from at least one other respective UL/DL subframe configuration. The positioning node comprises a processing circuit configured to generate the positioning assistance data while taking at least one respective UL/DL subframe configuration information into account, thereby building the positioning assistance data, and to send the positioning assistance data to the wireless device.

Thanks to that UL/DL subframe configuration information is taken into account by the wireless device when performing positioning measurements, measurements where for example no PRS exists are avoided. Hence, the wireless device performs positioning measurements when effective, i.e. when there for example PRS are sent from e.g. the first radio network node. Thus, improving positioning measurements performed by the wireless device. Accordingly, positioning performance of a telecommunication system, which for example includes the wireless device, has been improved by improving positioning methods in the positioning architecture of the above mentioned kind.

Moreover, thanks to that the UL/DL subframe configuration information is sent between the first radio network node and the positioning node, the positioning node is able to exploit the UL/DL subframe configuration information in order to improve positioning performance.

Advantageously, according to some embodiments herein, the positioning node has the possibility to exploit the UL/DL subframe configuration information and improve positioning performance when not all cells use the same UL/DL subframe configuration all the time.

In some embodiments, new signalling, which enhances positioning performance when not all cells use the same UL/DL subframe configuration all the time, is provided.

Methods for performing RSTD measurements, when UL/DL subframe configuration of neighbouring cells is uncertain, are also provided in some embodiments.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a block diagram illustrating a frame structure;

FIG. 2 is a block diagram illustrating another frame structure;

FIG. 3 is an overview illustrating an LTE positioning architecture;

FIG. 4 is a block illustration depicting positioning subframe allocation;

FIG. 5 a schematic overview of an exemplifying radio communication network in which embodiments herein may be implemented;

FIG. 6 is a schematic, combined signalling scheme and flowchart illustrating embodiments of the methods herein when performed in the radio communication network according to FIG. 5,

FIG. 7 is a further schematic, combined signalling scheme and flowchart illustrating embodiments herein;

FIG. 8 is a flowchart illustrating embodiments of the method in the wireless device;

FIG. 9 is a block diagram illustrating embodiments of the wireless device;

FIG. 10 is a flowchart illustrating embodiments of the method in the first radio network node;

FIG. 11 is a block diagram illustrating embodiments of the first radio network node;

FIG. 12 is a flowchart illustrating embodiments of the method in the positioning node; and

FIG. 13 is a block diagram illustrating embodiments of the positioning node.

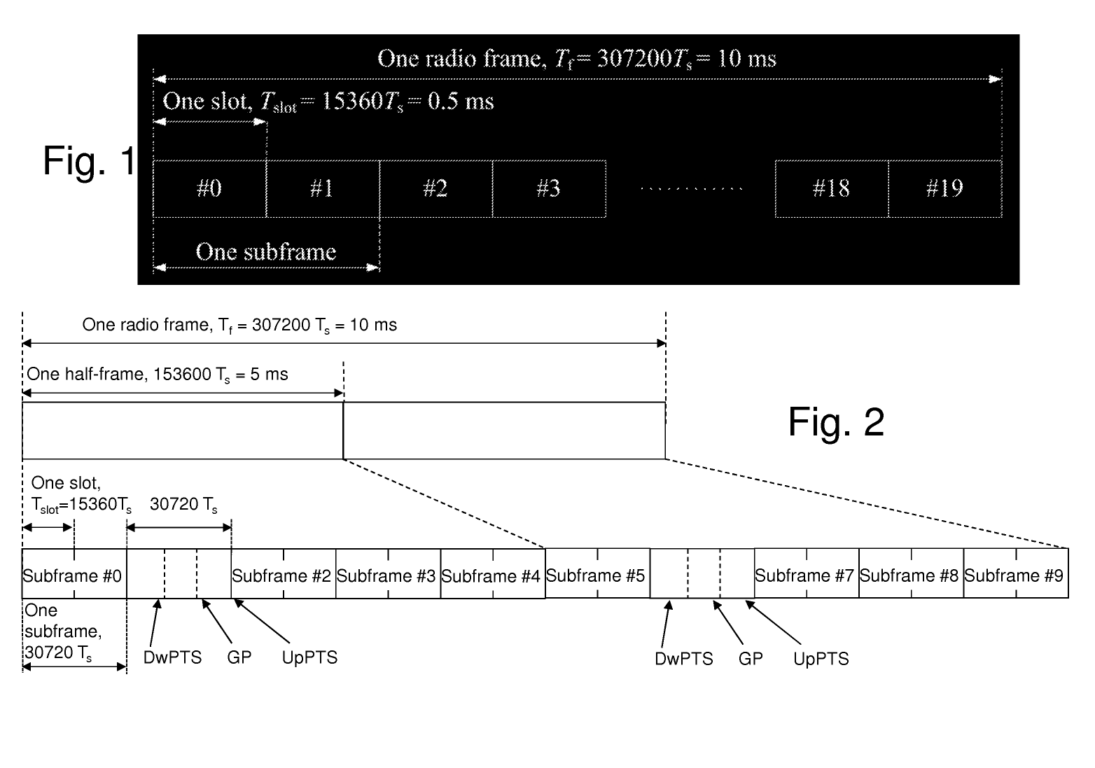

### DETAILED DESCRIPTION

The following analysis of existing solutions is meant to facilitate understanding of benefits and advantages of the embodiments presented in the subsequent description with reference to the Figures.

Hence, at least the following problems may be envisioned with the existing solutions.

No or limited information about UL/DL subframe configuration for neighbouring cells measured for positioning (unless it is known the configuration is the same in all cells) makes it difficult for the UE to correctly determine PRS subframes.

UE may receive UL/DL subframe configuration information for a serving cell (PCell or SCell) by reading SIB1 or via dedicated signalling (e.g., at handover). If UL/DL subframe configurations may be different in different cells, the UE have no information about the UL/DL subframe configurations in neighbouring cells, it does not receive it in the assistance data and it won't be able to always read this information from SI of the neighbouring cells since positioning signals are much weaker, e.g. a required signal strength of about −13 dB (Es/lot=−13 dB), than SIB reading requirement, e.g. a required signal strength of about −6 dB).

With dynamic UL/DL subframe configuration, the UL/DL subframe configuration may change more frequently than positioning assistance data is transmitted.

For example, it is expected that UL/DL subframe configuration may change 50˜200 ms, whilst the maximum PRS periodicity is 1280 ms and multiple positioning occasions are typically necessary for RSTD measurements, e.g., up to 8, 16, or 32 positioning occasions.

Signalling a new configuration upon a change in each cell from eNB to positioning server and then from positioning server to UE would lead to high signalling overhead.

Accordingly, at least some of the problems are solved according some of the embodiments disclosed herein.

Throughout the following description similar reference numerals have been used to denote similar elements, network nodes, parts, items or features, when applicable.

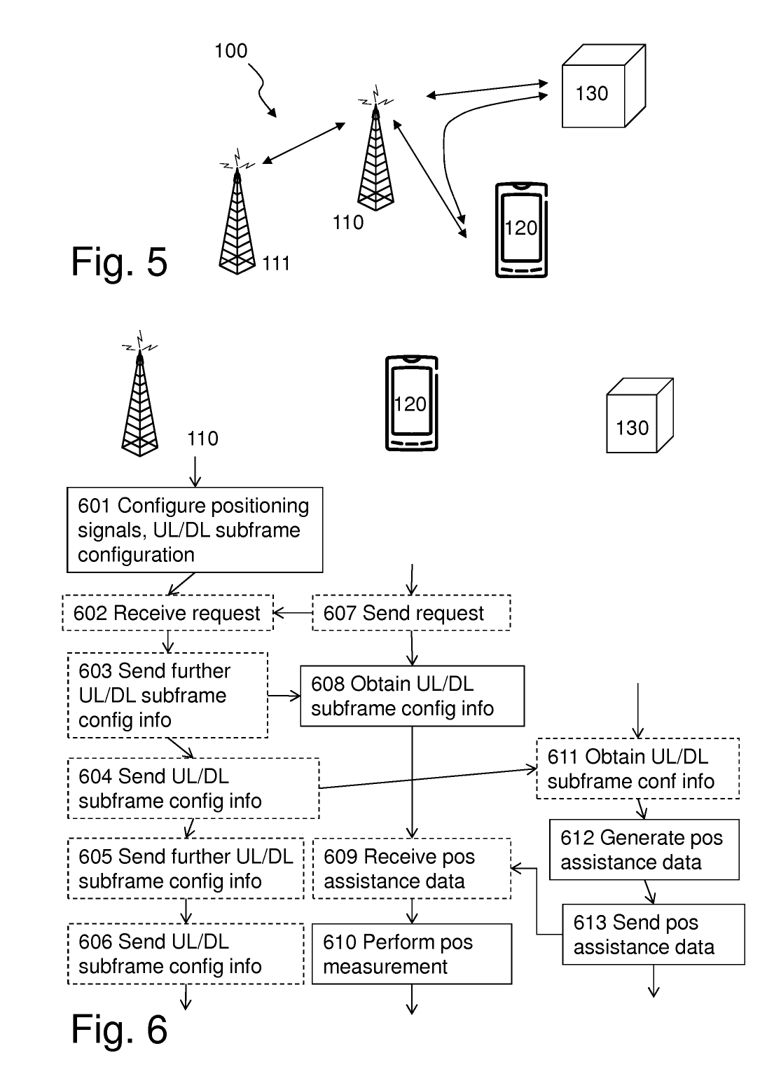

FIG. 5 depicts an exemplifying radio communications system 100 in which embodiments herein may be implemented. In this example, the radio communications system 100 is a Long Term Evolution (LTE) system.

The radio communication system 100 comprises a first radio network node 110. As used herein, the term “radio network node” may refer to an evolved Node B (eNB), a control node controlling one or more Remote Radio Units (RRUs), a radio base station, a transmitter, a transmitter side, an access point or the like. The radio network node 110 may implement evolved UMTS Terrestrial Radio Access Network (E-UTRAN) technologies, where UTMS is short for Universal Mobile Telecommunications System. Moreover, a second radio network node 111 neighboring to the first radio network node 110 is shown. The second radio network node 111 may sometimes be referred to as another radio network node or a further radio network node.

Furthermore, a wireless device 120 is located in the vicinity of the first radio network node 110. The wireless device 120 may communicate with the first radio network node 110. As used herein, the term “wireless device”, or “user equipment”, may refer to a mobile phone, a cellular phone, a wireless device, a Personal Digital Assistant (PDA) equipped with radio communication capabilities, a receiver, a mobile station (MS), a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic switch, a microphone, a loudspeaker, a camera sensor etc. Hence, a wireless device and UE may be used interchangeably in the description.

Moreover, the radio communication system 100 comprises a positioning node 130. The positioning node may be a positioning server, e.g. Evolved Serving Mobile Location Center (Evolved SMLC or E-SMLC) or SLP in LTE, or even the wireless device 120.

The first radio network node 110 is characterized by its ability to transmit and/or receive radio signals and it may comprise a transmitting or receiving antenna.

The wireless device 120 may comprise any device equipped with a radio interface and capable of at least transmitting or receiving a radio signal from another radio node. The wireless device 120 may also be capable of receiving signal and demodulate it. Note that even some radio network nodes, e.g., femto Base Station (BS), or home BS, may also be equipped with a UE-like interface. As mentioned, some example of “UE” that are to be understood in a general sense are PDA, laptop, mobile, a tablet device, sensor, fixed relay, mobile relay, any radio network node equipped with a UE-like interface (e.g., small RBS, eNodeB, femto BS).

A radio network node is a radio node comprised in a radio communications network. A radio network node may be capable of receiving radio signals or transmitting radio signals in one or more frequencies, and may operate in single-Radio Access Technology (RAT), multi-RAT or multi-standard mode, e.g. Multi-Standard RAT (MSR). A radio network node, including eNodeB, RRH, Radio Remote Unit (RRU), relay, Location Measurement Unit (LMU), or transmitting-only/receiving-only radio network nodes, may or may not create own cell. Some examples of radio network nodes not creating own cell are beacon devices transmitting configured radio signals or measuring nodes receiving and performing measurements on certain signals (e.g., LMUs). It may also share a cell or the used cell ID with another radio node which creates own cell, it may operate in a cell sector or may be associated with a radio network node creating own cell. More than one cell or cell sectors (commonly named in the described embodiments by a generalized term “cell” which may be understood as a cell or its logical or geographical part) may be associated with one radio network node. Further, one or more serving cells (in DL and/or UL) may be configured for a UE, e.g., in a carrier aggregation system where a UE may have one Primary Cell (PCell) and one or more Secondary Cells (SCells). A cell may also be a virtual cell (e.g., characterized by a cell ID but not provide a full cell-like service) associated with a transmit node.

A network node may be any radio network node, see the corresponding description above, or core network node. Some non-limiting examples of a network node are an eNodeB (also radio network node), RNC, positioning node, MME, Public Safety Answering Point (PSAP), Self-Optimized Network (SON) node, Minimizing Drive Test (MDT) node, coordinating node, a gateway node (e.g., Packet Data Network Gateway (P-GW) or Serving Gateway (S-GW) or LMU gateway or femto gateway), and Operation & Maintenance (O&M) node.

The term “coordinating node” used herein is a network and/or node, which coordinates radio resources with one or more radio nodes. Some examples of the coordinating node are network monitoring and configuration node, Operation and Support System (OSS) node, O&M, MDT node, SON node, positioning node, MME, a gateway node such as P-GW or S-GW network node or femto gateway node, a macro node coordinating smaller radio nodes associated with it, eNodeB coordinating resources with other eNodeBs, etc.

The signalling herein may be either physical-layer signalling or higher-layer (e.g., Layer 2 or Layer 3) signalling, and it may be via direct links or logical links (e.g. via higher layer protocols and/or via one or more network and/or radio nodes). For example, signalling from a coordinating node to a UE may also pass another network node, e.g., a radio network node.

The described embodiments are not limited to LTE, but may apply with any Radio Access Network (RAN), single- or multi-RAT. Some other RAT examples are LTE-Advanced, UMTS, High Speed Packet Access (HSPA), Global System for Mobile Communication (GSM), Code Division Multiple Access 2000 (CDMA2000 or cdma2000), WiMAX, and WiFi.

The embodiments presented herein may also apply to multi-point transmission and/or reception systems, carrier aggregation systems, and multi-point carrier aggregation systems.

The term “subframe” used in the embodiments described herein (typically related to LTE) is an example resource in the time domain, and in general it may be any pre-defined time instance or time period.

Downlink positioning measurement herein is any positioning measurement involving measuring at least one downlink radio signal, e.g., PRS. In one example, the measurement may also involve measuring an uplink radio signal, e.g., as with two-directional measurements such as UE receive-transmit (Rx-Tx), eNB Rx-Tx, Round Trip Time (RTT), etc. In another example, the measurement may also involve measuring a second radio signal on a second downlink, e.g., RSTD measurement which is a time difference of two signals over two downlinks.

FIG. 6 illustrates an exemplifying method for managing a positioning measurement when implemented in the radio communication system 100 of FIG. 5.

Thus, the first radio network node 110 performs a method for configuring positioning reference signals, positioning subframes and/or an uplink/downlink, “UL/DL”, subframe configuration, wherein the first radio network node (110) uses multiple UL/DL subframe configurations in a cell of the first radio network node (110). In connection with the first radio network node reference is made to solution 3 below.

The wireless device 120 performs a method for performing a positioning measurement in the wireless communication network 100.

The positioning node 130 performs a method for building positioning assistance data to be used by the wireless device 120 when performing positioning measurements on a set of radio network nodes 110, 111. Each radio network node 110, 111 of the set of radio network nodes 110, 111 is associated with a respective UL/DL subframe configuration information. At least one respective UL/DL subframe configuration information is different from at least one other respective UL/DL subframe configuration information. In connection with the positioning node reference is made to solution 2 below.

The UL/DL subframe configuration information may comprise any one or more of: one or more complete UL/DL subframe configurations of one or more neighboring cells; a common set of DL subframes in one or more cells, wherein the common set may comprise subframes that are downlink subframes in different UL/DL configurations of different cells or in different UL/DL configurations of a cell; an indication of whether two or more different UL/DL configurations are used in one or more cells and a UL/DL configuration is received from a positioning node 130; an update time interval of an UL/DL subframe configuration; a current UL/DL subframe configuration used by the second radio network node 111; and an indication indicating a switching point of at least one UL/DL configuration.

It should be noted that complete UL/DL configurations of a neighboring cell may be provided by means of UL/DL configuration index or sequence of UL and DL indications for a radio frame. As an example, a complete UL/DL subframe configuration of one or more neighbouring cells may be that two or more neighboring cells have the same UL/DL configuration.

The following actions may be performed in any suitable order.

In order to better follow what happens in each of the first radio network node 110, the wireless device 120 and the positioning node 130, actions in each of these will be described in sequence while it shall be understood that the actions may be performed simultaneously or in a different order when applicable.

### Action 601

In order to provide, to the wireless device 120, signals on which it may perform positioning measurements, the first radio network node 110 configures positioning reference signals (PRS), positioning subframes and/or the UL/DL subframe configuration in a non-ambiguous set of downlink subframes.

The non-ambiguous set of downlink subframes may comprise a number of flexible subframes, wherein the number of flexible subframes is less than a threshold value. The term “flexible subframes” has its conventional meaning as defined in specifications of the 3GPP.

The configuring 601 of the PRS, the positioning signals and/or positioning subframes may comprise configuring number of positioning subframes and PRS configuration index to maximize number of downlink subframes until an upcoming special subframe. See section “solution 3” for further examples and explanations.

### Action 602

The first radio network node 110 may receive, from the wireless device 120, a request for the UL/DL subframe configuration information relating to the second radio network node 111. In this manner, the wireless device 120 may request the UL/DL subframe configuration information when required. See also action 607 below.

### Action 603

In order to inform the wireless device 120 about UL/DL subframe configuration in neighbouring cell, the first radio network node 110 may send further UL/DL subframe configuration information or a configuration comprising the non-ambiguous set of downlink subframes to the wireless device 120 for purpose of positioning. The further UL/DL subframe configuration information may thus relate to the second radio network node 111 neighboring to the first radio network node 110. As an example, the further UL/DL subframe configuration information may be sent via Radio Resource Control (RRC) signalling.

### Action 604

In order to make it possible for the positioning node 130 to take advantage of the UL/DL subframe configuration information, the first radio network node 110 may send at least one UL/DL subframe configuration information of the multiple UL/DL subframe configurations or the configuration comprising the non-ambiguous set of downlink subframes to the positioning node 130. As an example, the UL/DL subframe configuration information may be sent on LPPa. In action 611 and/or action 612, the positioning node 130 may use this information.

### Action 605

The first radio network node 110 may send further UL/DL subframe configuration information to a positioning node 130, wherein the further UL/DL subframe configuration information relates to the second radio network node 111 neighboring to the first radio network node 110.

As an example, the further UL/DL subframe configuration information may be sent on LPPa. In action 611 and/or action 612, the positioning node 130 may use this information.

### Action 606

The first radio network node 110 may send at least one UL/DL subframe configuration information for the multiple UL/DL subframe configurations to another network node for purpose of positioning. For example, said another network node may use the UL/DL subframe configurations to configure signals used for positioning, to configure positioning subframes, to include in the positioning assistance data sent to a measuring node, to select cells with certain UL/DL subframe configurations for positioning measurements if configuring positioning measurements for other measuring nodes, to select positioning method, e.g., DL-based when the UL/DL subframe configuration indicates more DL subframes, to adjust a timer associated with the time needed to perform measurements. Furthermore, said another network node may send the UL/DL subframe configurations to a measuring node.

### Action 607

The wireless device 120 may send, to the first radio network node 110, a request for the UL/DL subframe configuration information relating to the second radio network node 111. As seen in action 602, the first radio network node 110 may in this manner provide up-to-date UL/DL subframe configuration information to the wireless device 120 on request.

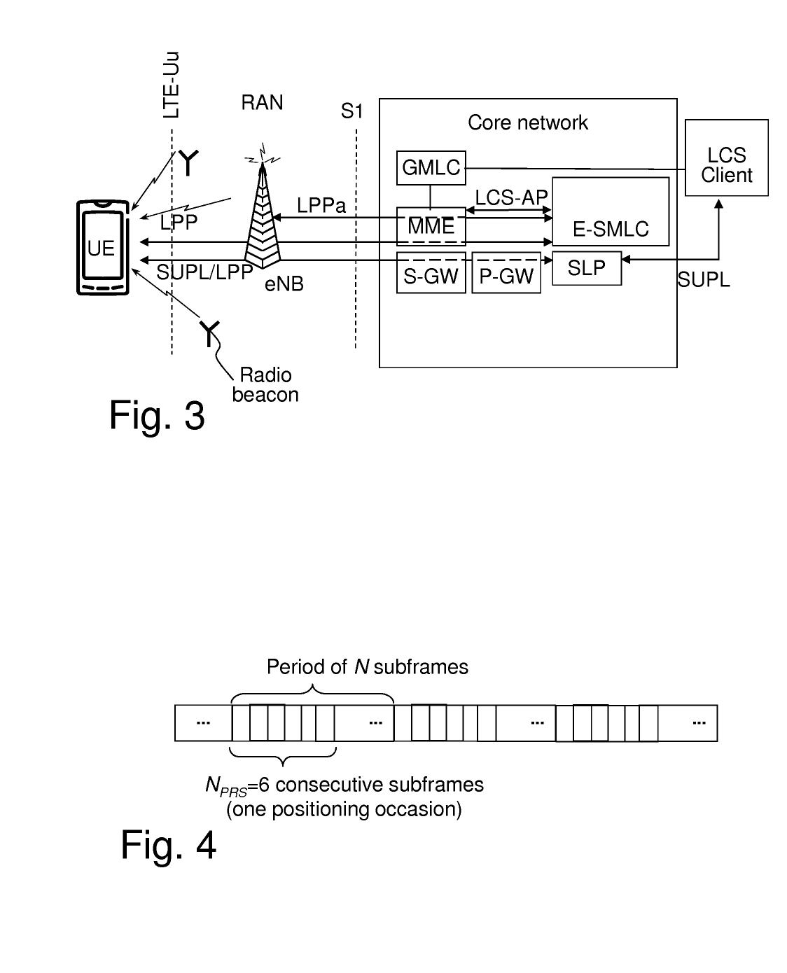

In further examples, the wireless device 120 may send the request for the UL/DL subframe configuration information to for example an MME, shown in FIG. 3. Moreover, the wireless device 120 may send the request to the positioning node 130.

### Action 608

The wireless device 120 obtains UL/DL subframe configuration information relating to the second radio network node 111. See also action 603 above. Further examples and description is provided in section “Solution 1”.

The UL/DL subframe configuration information may be obtained by that the wireless device 120 receives the UL/DL subframe configuration information, e.g. via RRC, from the first radio network node 110.

The UL/DL subframe configuration information may be obtained by that the wireless device 120 receives, on e.g. LPP, the UL/DL subframe configuration information from the positioning node 130.

The UL/DL subframe configuration information relating to the second radio network node 111 may be obtained by that the wireless device 120 determines the UL/DL subframe configuration information based on a pre-defined rule. The UL/DL subframe configuration information may be different from the UL/DL subframe configuration information relating to the first radio network node 110. See also section “Solution 4”.

The UL/DL subframe configuration information relating to the second radio network node 111 may be obtained by that the wireless device 120 determines a non-ambiguous set of downlink subframes, and the performing 610 of the positioning measurement below further comprises performing the positioning measurement in the determined non-ambiguous set of downlink subframes. See also section “Solution 4”.

### Action 609

In some examples, the wireless device 120 may obtain the UL/DL subframe configuration information as positioning assistance data. Hence, the wireless device 120 may receive positioning assistance data from the positioning node 130. This means that, since the positioning assistance data may include the UL/DL subframe configuration information, the wireless device 120 may perform action 610 below.

### Action 610

The wireless device 120 performs the positioning measurement while taking the obtained UL/DL subframe configuration information into account. Hence, the wireless device may e.g. avoid positioning measurements when there is no signal to measure on, such as in an UL subframe or in subframes where the first and/or second radio network node does not transmit e.g. PRS.

As an example, the wireless device 120 performs the positioning measurement while meeting a pre-defined requirement. The pre-defined requirement may be a requirement relating to time for measurement or a requirement relating to accuracy of measurement.

### Action 611

The positioning node 130 may obtain the respective UL/DL subframe configuration information by one or more of:
receiving the respective UL/DL subframe configuration information from at least one of the radio network nodes 110, 111 of the set of radio network nodes 110, 111, see also action 604;
receiving the respective UL/DL subframe configuration information from another node;
retrieving the respective UL/DL subframe configuration information from a database; and
retrieving the respective UL/DL subframe configuration information from cell data.

See also section “Methods in a positioning server of obtaining UL/DL subframe configuration information”.

Cell data may be information about a cell, either pre-coded, or configured, or received from another node, e.g. via standardized or non-standardized interface. Cell data may be collected from different sources, e.g. received via O&M, from eNB, even from UE, etc.

### Action 612

The positioning node 130 generates the positioning assistance data while taking at least one respective UL/DL subframe configuration information into account, thereby building the positioning assistance data. In some examples, the positioning node 130 may generate the positioning assistance data while taking the non-ambiguous set of downlink subframes into account.

The generation 612 of the positioning assistance data may be performed by the positioning node 130 by one or more of selecting a positioning method to be included in the positioning assistance data; selecting radio nodes whose radio signals are to be measured by the wireless device 120, wherein information related to said radio nodes is to be included in the positioning assistance data; selecting a reference cell to have information about selected reference cell included in the positioning assistance data; and modifying a positioning subframe configuration included in the positioning assistance data.

### Action 613

In order for the wireless device 120 to be able to use the positioning assistance data, the positioning node 130 sends the positioning assistance data to the wireless device 120. See also action 609 above.

### Solution 1: Methods of Obtaining UL/DL Configuration for Positioning Measurements

According to an embodiment herein, UL/DL subframe configuration data (e.g., UL/DL subframe configuration of at least one neighbouring cell, different from that of a serving cell) is obtained by the wireless device 120 for positioning measurements. These data may be obtained, e.g., via
1. explicit signalling from a second node (e.g., higher layer signalling, physical layer signalling, reading system information (SI) of a neighbouring cell, etc.),
   In one example, the signalled UL/DL subframe configuration data may be comprised in the positioning assistance data or received during a positioning session. A positioning session lasts for a time during which a measuring node is performing all necessary positioning measurements for one or more cells, reporting and communication with other nodes. As an example, positioning occasion, defined in 3GPP TS 36.133 for OTDOA, is cell-specific, spanning up to 6 downlink subframes; a measuring node may need more than one positioning occasions for measuring the corresponding (one) cell.
2. performing radio measurements, e.g. by performing correlation on known signals specific for DL or UL subframes and determining whether these signals are present. Thereby, the corresponding subframe type, i.e. DL or UL, may be determined.
3. determining by the wireless device 120 based on a pre-defined rule applied to data received in positioning assistance data (see e.g. Solution 4).

Some examples of the second node are the positioning node 130 such as a positioning server (e.g., signalling from E-SMLC or SLP via LPP or LPPe to wireless device) and eNB, e.g., signalling to wireless device via Radio Resource Control (RRC).

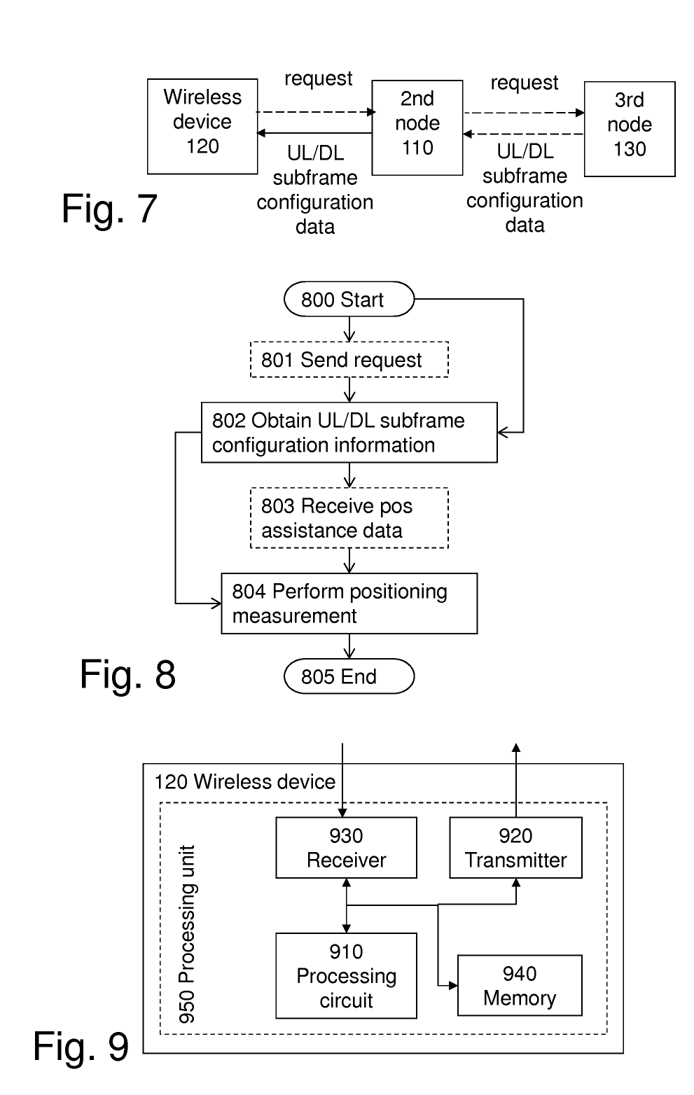

In another embodiment, with reference to FIG. 7, the wireless device 120 may request the UL/DL subframe configuration for performing positioning measurements from the second node, e.g. the first radio network node 110. In one example, the request may be sent when the wireless device 120 is not aware of the UL/DL subframe configuration on a neighbouring cell or when the wireless device 120 has determined that some cells may have a different UL/DL subframe configuration from a serving cell. In yet another example, the request may also comprise an indication that UL/DL subframe configuration may be or is different from a serving cell. The request may also comprise a list of cells and/or frequencies for which UL/DL subframe configuration data are requested.

In yet another embodiment, the second node may obtain (in unsolicited way or upon request) these data, prior to sending to the wireless device, from a third node, e.g.,
positioning server obtains the UL/DL subframe configuration data from eNB (e.g., via LPPa), O&M, gateway (e.g., femto gateway), or coordinating node,
eNB obtains the UL/DL subframe configuration data from another eNB (e.g., via X2), O&M, gateway (e.g., femto gateway), or coordinating node.

In some examples, the third node may be the positioning node 130.

The second node may also process the UL/DL subframe configuration data and send to the wireless device the result of processing. The processing may comprise, e.g., any one or more of: selecting a subset of data (e.g., send if different from a reference such as serving cell UL/DL subframe configuration), obtaining UL/DL subframe configuration which is a function of one or more UL/DL subframe configurations obtained from the third node, etc.

Continuing with reference to FIG. 7, the wireless device 120, which obtains the UL/DL subframe configuration data, may perform at least one positioning measurement adaptively to the obtained data. For example, the wireless device 120 may use the obtained UL/DL subframe configuration data for determining downlink subframes for positioning measurements such as subframes with transmitted PRS and avoid incorrectly performing DL measurements in UL subframes or special subframes of the neighbouring cells. Some other examples of using switching point information (partial, or incomplete, UL/DL subframe configuration information) are provided in Solution 4.

### UL/DL Subframe Configuration Information

The UL/DL subframe configuration information may comprise, e.g.,
current UL/DL subframe configuration(s), complete information or its part (e.g., switching point information only), used in said one or more radio nodes or cells,
UL/DL subframe configuration update time interval, if the configuration changes in time,
information about similarity (e.g., exactly same/not same or have the same switching point or not) of UL/DL configurations in two or more radio nodes or cells,
information about similarity over time (e.g., changing/not changing) of UL/DL configuration in one or more radio node(s) or cell(s).

The UL/DL subframe configuration may be associated with one or more radio nodes or cells (e.g., determined by identity, list, or certain properties such as BS type), an area, one or more carrier frequencies, frequency band, etc.

Enhanced Assistance Data Accounting for Different and/or Dynamic UL/DL Subframe Configuration

Including the information related to UL/DL subframe configuration in the positioning assistance data (see also Solution 1), e.g., any one or more of:
Including an indicator for one or more cells indicative of that one, some or all cells may use dynamic UL/DL subframe configuration
Including an indicator for one or more cells indicative of that one, some or all cells may use UL/DL subframe configuration different that a reference configuration or a configuration of a certain cell (e.g. serving cell)
Including the switching point (5 ms or 10 ms) information to describe UL/DL subframe configuration or an indication whether some or all cells in the list use the same or different switching point
Including the actual UL/DL subframe configuration for one or more cells, a modified UL/DL subframe configuration (e.g., a minimum configuration for two or more configurations such as a minimum configuration for the OTDOA neighbour cell and OTDOA reference cell), a non-ambiguous set of subframes (see e.g. Solution 4) for measurements for one or more cells in positioning assistance data, or a configuration or pattern indicating flexible (that may be DL or UL) set of subframes, e.g., when
   it is different from the serving cell
   it is different from the reference cell
   different UL/DL subframe configurations may occur two or more cells in the positioning assistance data
   one or more cells in the positioning assistance data may have a different UL/DL subframe configuration from a reference configuration, e.g., from the configuration in a serving cell (PCell or SCell)
   UL/DL subframe configuration may change over time
Including a time or data indicative of the time during which the UL/DL subframe configurations of the cells are unchanged, e.g.,
   When UL/DL subframe configuration of a cell may change, the configuration update interval or the validity time may be included in the positioning assistance data
Sending an indication of that an UL/DL subframe configuration earlier sent in the positioning assistance data has changed or sending the updated configuration information

In one example, this may be done when the change also impacts the set of positioning subframes (see also Solution 2 on evaluation the change).

In one embodiment, any of the above ways of including the UL/DL subframe configuration may also be received from a third node, as described above.

The wireless device 120 may be required to perform at least one positioning measurement and meet one or more pre-defined requirements. Some example requirements are measurement time requirements or accuracy requirements. In these embodiments, the wireless device 120 may be required to meet a requirement based on one of the above enhanced signalling elements, e.g., based on the received non-ambiguous set of downlink subframes when the complete UL/DL configuration is not available or based on the received UL/DL configuration or based on the UL/DL subframe configuration properties described by the enhanced signalling. The requirements may in addition differ for different bandwidths, intra- and inter-frequency measurements. It may depend also on the wireless device 120 capability to perform measurements without measurement gaps or CA capability.

### Solution 2: Method in a Positioning Server for Building Positioning Assistance Data Adaptively to UL/DL Subframe Configuration Information

According to an embodiment herein, a positioning server obtains the UL/DL subframe configuration information for one or more radio nodes or cells and builds positioning assistance data, adaptively to the obtained UL/DL subframe configuration. The positioning assistance data is then signalled to another radio node (e.g., to one or more wireless devices) to assist in positioning measurements, wherein the positioning assistance data may be provided via dedicated signalling or multicast/broadcast. The positioning assistance data may also be provided to a wireless device 120 via another node (e.g., eNodeB and/or MME), which may or may not modify the positioning assistance data.

The UL/DL subframe configuration information may be, e.g., as described in Solution 1.

Positioning server can be a positioning node (e.g., E-SMLS or SLP in LTE) or any node configured as a positioning server.

In one embodiment, the positioning assistance data may be created taking also into account wireless device measurement capability associated with UL/DL configurations (e.g., measurements on cells with different and/or dynamic UL/DL configurations). The capability may or may not be specific to positioning measurements. In one example, this capability may be sent by the wireless device 120 to the positioning server, in unsolicited way or upon a request. In another example, this capability may be obtained by the positioning server from a node different from the wireless device 120 (e.g., from serving eNodeB) or determined autonomously based on its reports.

Optionally, the built positioning assistance data may be stored and reused for another wireless device, statistics collection, or another positioning purpose.

In one example, positioning is TDOA-based positioning such as OTDOA positioning in LTE and positioning measurements are RSTD measurements. In another example, positioning is E-CID positioning, AECID positioning, pattern matching, or Radio Frequency (RF) fingerprinting positioning and positioning measurements are measurements involving neighbouring cells measurements such as received signal strength, received signal quality, or timing (e.g., timing advance, UE Rx-Tx, eNB Rx-Tx, or RTT) measurements.

Building the positioning assistance data adaptively to the obtained UL/DL subframe configuration may comprise, e.g., any one or more of:
Selecting a positioning method, e.g.,
   Selecting OTDOA if at least M cells for which the UL/DL subframe configuration meets a certain criteria (e.g., M cells use the same and/or static UL/DL subframe configuration; M cells use the same and/or static UL/DL subframe configuration; see also below the example criteria for inclusion radio nodes or cells in the positioning assistance data) and can be included in the positioning assistance data; otherwise select a different positioning method
Selecting radio nodes or cells whose radio signals are to be measured by the wireless device 120 for positioning such that UL/DL subframe configurations of said radio nodes or cells meet one or more criteria, e.g.,
   cells with the same UL/DL configurations may be included in the positioning assistance data for positioning measurements
   cells with similar UL/DL configurations (e.g., only with the same, 5 ms, switching point) may be included in the positioning assistance data for positioning measurements
   cells with at least K consecutive subframes without UL subframes in-between may be included in the positioning assistance data for positioning measurements
   cells with different UL/DL configurations on one or more frequencies may be included in the positioning assistance data for positioning measurements if the wireless device 120 supports measurements on cells with different UL/DL configurations one or more frequencies, respectively
   a cell with dynamically configured UL/DL configuration may be included in the positioning assistance data for positioning measurements if the wireless device 120 supports measurements on cells with dynamically configured UL/DL configurations
Selecting a reference cell, e.g.,
   Select as a reference cell the cell with an UL/DL configuration meeting a certain criteria (e.g., same as that of the serving cell; having at least L number of DL subframes or having the maximum number of DL subframes among the cells in a list, etc.)
Modifying positioning subframe configuration providing to the wireless device 120 in positioning assistance data (e.g., number of consecutive positioning subframes, PRS configuration index to be indicated in the positioning assistance data, etc.)
   In one example, the number of consecutive positioning subframes configured for positioning measurements in the positioning assistance data may be different from that which is currently used for PRS transmissions in a cell (e.g., when UL/DL subframe configuration may dynamically change over time). For example, positioning server may modify (reduce) Nprs such that all positioning subframes indicated by this modified Nprs are only downlink subframes without UL subframes in-between. This would allow any wireless device to always assume that all Nprs (as configured in the positioning assistance data) consecutive subframes are DL subframes, without acquiring UL/DL subframe configuration for each neighbouring cell (reading SI is very resource consuming and may be not possible to weak signal quality).

### Example

Assume that a TDD cell has UL/DL subframe configuration #4 and transmits PRS in subframes indicated as ‘D*’ below.

| | | | | | | | | | | | |
|---|---|---|---|---|---|---|---|---|---|---|---|
| Conf#1 | 5 ms | D* | S | U | U | D* | D* | S | U | U | D* |

Nprs=4 is a valid parameter which is likely to be sent by the cell via LPPa to E-SMLC. However, UE may be not aware of that there are UL subframes and a special subframe between some PRS subframes. This is because there exists other UL/DL subframe configurations with 4 consecutive DL subframes without UL subframes in between, e.g., configuration #4. Positioning server may modify and set Nprs=2 in the positioning assistance data, with which in all possible UL/DL subframe configurations with PRS starting in subframe #4 the two consecutive subframes will never have UL subframes or special subframes in-between:

| Uplink- | Downlink-to- | | | | | | | | | | | |
|---|---|---|---|---|---|---|---|---|---|---|---|---|
| downlink | Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Verifying that PRS configuration index always indicates a feasible TDD configuration, e.g., the first subframe of the positioning subframe in the PRS configuration received from eNB never points to an UL subframe or special subframe, when the eNB uses dynamic UL/DL subframe configuration. As a result of verification, positioning server may also return an error to indicate an incorrect configuration.
Sending updated the positioning assistance data when UL/DL subframe configuration of one or more cells has changed or will change, which may comprise, e.g., any one or more of:
   Evaluation the change (e.g., whether the change affects the set of subframes for positioning measurements, which may depend on the PRS configuration index and the number Nprs of consecutive DL subframes with PRS)
   Sending the positioning assistance data (e.g., always upon a change of the UL/DL subframe configuration of one or more cells included in the earlier sent positioning assistance data or depending on the result of the evaluation of the change—do not send if no impact on the positioning measurements)
Including the information related to UL/DL subframe configuration in the positioning assistance data (see also Solution 1)

### Methods in a Positioning Server of Obtaining UL/DL Subframe Configuration Information

The positioning server may obtain the UL/DL configuration data in one or more ways, e.g., by one or more of:

Receiving it from another node (e.g., from one or multiple radio network nodes via LPPa; from O&M or SON; or from the wireless device 120), in an unsolicited way or upon a request

Retrieving it from a Database or a Storage Device or Memory Retrieving from Cell Data

Determining based on reports from one or more radio nodes (e.g., radio network nodes or wireless devices), e.g., the wireless device 120 may report the exact UL/DL configuration used in one or more radio nodes, indicate whether it is the same or not than a reference configuration (e.g., used in a serving cell), or indicate whether neighbouring cells use the same or not UL/DL subframe configuration.

This information may be comprised, e.g., in a measurement report, failure report (e.g., indicating that a failure is due to different UL/DL configurations in two radio nodes or cells), etc.

### Solution 3: Methods of Configuring Positioning Subframes and UL/DL Subframe Configuration

According to these embodiments, a radio node (e.g., eNB or O&M) configures UL/DL subframe configurations and positioning subframes (e.g., subframes for PRS signal transmission comprising Nprs parameter and PRS configuration index defined in 36.211) for DL positioning measurements according to one or more rules below:

When dynamic UL/DL subframe configuration is used in the node or cell, the same PRS configuration index may be used with two or more dynamically configured UL/DL subframe configurations and the PRS configuration index (indicating also a first positioning subframe in a positioning occasion) always points to a DL subframe and not to an UL subframe or special subframe, e.g., when one or more of the below holds:

Always when PRS are configured in the node or cell

When PRS periodicity is shorter than UL/DL subframe configuration change interval

When dynamic UL/DL subframe configuration is used in the node or cell and PRS are configured, use UL/DL subframe configurations with the same switching point (e.g., only 5 ms or only 10 ms), e.g., when one or more of the below holds:

Always when PRS are configured in the node or cell

For a subset of PRS periodicity values only

When not all nodes or cells use the same UL/DL subframe configuration (e.g., known based on the data received from O&M, a neighbour node, or a wireless device 120) or when the UL/DL subframe configuration may dynamically change, configure Nprs and PRS configuration index to maximize the number of DL subframes until the next special subframe or to leave at least Nprs downlink subframes (where Nprs is determined by the requirements in 36.133, Section 9.1.10). Such rule may enable, e.g., the maximum number of DL subframes in non-ambiguous set of downlink subframes.

When dynamic UL/DL subframe configuration is used in the node or cell and PRS are configured, the number of PRS subframes in flexible subframes should not exceed a threshold (e.g., 0 or 1 within a radio frame) which is smaller than Nprs specified by RSTD accuracy requirements in 36.133. This is because having all PRS subframes in flexible subframes may increase UE complexity when complete UL/DL subframe configuration is not available and the UE may need to blindly determine the configuration.

Positioning subframes are configured in subframes comprised in a minimum non-ambiguous set of downlink subframes, e.g., at least in subframe #0 and also in subframe #5 when switching point is 5 ms and known to the wireless device 120.

The adapted in the way described above positioning subframe configuration may further be signalled to another node, e.g., positioning server (see e.g., Solution 1 and Solution 2), a neighboring radio network node, or the wireless device 120 performing positioning measurements in the downlink positioning subframes.

Solution 4: Methods in a Wireless Device of Performing Positioning Measurements with Multiple UL/DL Subframe Configurations

In Solution 1, a wireless device 120 may obtain complete UL/DL subframe configuration (in some embodiments) and perform positioning measurements using the obtained information. Unlike in Solution 1, in these embodiments, we assume that the wireless device 120 does not have complete UL/DL subframe configuration (e.g., for dynamically changing UL/DL subframe configuration a complete configuration would be the information about all configurations, their sequence in which they are configured and when they are configured) for at least one measured neighbour radio node (e.g., eNB, relay, wireless device, etc.) or cell, and the UL/DL subframe configuration for at least one measured neighbouring cell is different from a serving cell and/or may change dynamically, and has been requested to perform a positioning measurement.

Observe that the UE may even know the set of UL/DL subframe configurations used in the network, but it may not know which cell and/or when uses a specific configuration; hence, in this case, the UL/DL subframe configuration is incomplete too.

According to a basic embodiment herein, when the UL/DL subframe configuration is incomplete, the wireless device 120 determines a non-ambiguous set of downlink positioning subframes for performing at least one positioning measurement on signals transmitted by a radio node or cell in all subframes of said determined non-ambiguous set and performs said positioning measurement in the determined set of non-ambiguous set of positioning subframes.

The non-ambiguous set may be a minimum set (e.g., when no or very limited information is available) or the wireless device 120 may use additional information to increase the non-ambiguous set and improve positioning performance and reduce measurement processing requirements (e.g., DSP, memory, etc.).

In one embodiment, for the determining the wireless device 120 may use the positioning assistance data received from a positioning server (e.g., as standardized in 36.355 or the enhanced positioning assistance data described in Solution 1 when the complete UL/DL subframe configuration is still not available). For example, the said non-ambiguous set may depend on the bandwidth configured for positioning measurements (e.g., PRS bandwidth) and/or number of consecutive subframes (e.g., Nprs in OTDOA assistance data). The said determined non-ambiguous set may be smaller than the set of positioning subframes defined (e.g., by means of Nprs) in the positioning assistance data.

In one embodiment, the non-ambiguous set of positioning subframes may comprise a set of common downlink subframes that can be used for said positioning measurement. A common set comprises a set of downlink subframes common in two or more UL/DL subframe configurations. In one example, the two UL/DL subframe configurations are the two configurations of the same radio node or cell, e.g., when the configurations may change dynamically. In another example, the two UL/DL subframe configurations are the two possible configurations of different radio nodes or different cells.

For example, the switching point information may be used to determine the non-ambiguous set. For example, it may be known that a cell has the same switching point (5 ms or 10 ms) as the reference configuration (e.g., UL/DL configuration of the serving cell) or that dynamic UL/DL configurations use the same switching point.

### Example 1

An example set of common downlink subframes for all UL/DL subframe configurations is a set of downlink subframes comprised in configuration #0:

| | | | | | | | | | | | |
|---|---|---|---|---|---|---|---|---|---|---|---|
| Conf#0 | 5 ms | D | S | U | U | U | D | S | U | U | U |

Configuration #0 may be used as a default for DL positioning measurements. However, this would result in very sparse DL measurements and thus degraded measurement accuracy. Furthermore, this configuration is not an applicable configuration, e.g., for 1.4 MHz and 3 MHz PRS bandwidth, in intra-frequency RSTD measurement requirements (TS 36.133, Section Table 8.1.2.5.2-2). For configurations #2-6, the below is the common set:

| | | |
|---|---|---|
| D | D | D |

### Example 2

### Using Switching Point Information

For all configurations with switching point 10 ms, the common set of DL subframes is comprised in configuration #3:

| | | | | | | | | | | | |
|---|---|---|---|---|---|---|---|---|---|---|---|
| 3 | 10 ms | D | S | U | U | U | D | D | D | D | D |

### Example 3

### Using PRS Configuration Index Information

For example, PRS configuration index received in the positioning assistance data indicating PRS positioning occasion starting in subframe #3 may give at least the following common set (assuming the first positioning subframe in a positioning occasion always indicates a downlink subframe):

| | | | |
|---|---|---|---|
| D | D | D | D |

and also for subframe #3 but for switching point of 10 ms:

| | | | | | | | |
|---|---|---|---|---|---|---|---|
| D | D | D | D | D | D | D | D |

For PRS positioning occasion starting in subframe #6 (only possible for switching point 10 ms):

| | | | | | |
|---|---|---|---|---|---|
| D | D | D | D | D | D |

### Meeting Pre-Defined Requirements

The wireless device 120 may be required to perform at least one positioning measurement and meet one or more pre-defined requirements. Some example requirements are measurement time requirements or accuracy requirements. The wireless device 120 would then adapt its receiver and the positioning measurement procedure to meet the requirement.

In these embodiments, the wireless device 120 may be required to meet a first set of requirements comprising at least one requirement, based on a non-ambiguous set of downlink subframes when the complete UL/DL configuration is not available, e.g., when neighbour radio node or cell may use UL/DL subframe configuration different from that of the serving cell and/or the UL/DL subframe configuration of a radio node or cell may change in time. The requirements may be different from a similar type of requirements (e.g., measurement time or accuracy) for the case when UL/DL subframe configuration is known, aka a second set of requirements.

Additionally, the requirements may also depend on bandwidth, on whether is intra- or inter-frequency measurements, wireless device activity state. It may depend also on the wireless device capability to perform measurements without measurement gaps or CA capability.

The first and the second set of requirements may be the same when the measurements are performed infrequently in time, e.g., not more frequent than once per radio frame which may be the case, e.g., for DRX period longer than 10 ms or when the measurements are performed in measurement pattern indicating one measurement subframe per one or more radio frames. To meet such a requirement with uncertain UL/DL subframe configuration, the wireless device 120 would have to be able to determine the non-ambiguous set of subframes such that it comprises the subframe indicated by pattern for measurements and/or the subframe when the wireless device 120 is active. In another example, the wireless device 120 adapts its activity state periods to the non-ambiguous set of downlink subframes.

The first and the second set of requirements may be also the same when Nprs is below a threshold, e.g., Nprs=1 (for which the trivial non-ambiguous set of downlink subframes may be used). To meet such a requirement, the non-ambiguous set of subframes would have to comprise the positioning subframe corresponding to PRS configuration (see also Solution 3, configuring PRS at least in subframe #0).

The non-ambiguous set may be pre-defined or may be pre-configured in the wireless device 120.

In the above detailed description, the following embodiments are thus described:
Methods in a wireless device of performing positioning measurements when UL/DL subframe configuration is uncertain.
Method in a positioning server for building positioning assistance data adaptively to UL/DL subframe configuration information.
Methods of obtaining UL/DL configuration for positioning measurements.
Methods of configuring positioning subframes and UL/DL subframe configuration.

Embodiments described herein are not limited to TDD and may also apply to any system that may implement or imitate non-full duplex operation, including HD-FDD.

As mentioned, according at least some embodiments one or more of the following advantages may be achieved:
Possibility for positioning server to exploit the UL/DL subframe configuration information and improve positioning performance when not all cells use the same UL/DL subframe configuration all the time.
New signalling enhancing positioning when not all cells use the same UL/DL subframe configuration all the time.
Methods for performing RSTD measurements when UL/DL subframe configuration of neighbouring cells is uncertain.

According to the embodiments herein, there is provided a method in a wireless device, or user equipment, for handling UL/DL configuration for use when performing positioning measurements, comprising at least one of:

receiving information about the UL/DL configuration from a network node, such as a positioning server; and

performing positioning measurements while taking the received information about UL/DL subframe configuration into account.

Moreover, there is provided a wireless device configured to perform the method according to the method in the wireless device directly above.

Furthermore, there is provided a method in a network node for managing positioning assistance data to be used by a wireless device when performing positioning measurements, comprising at least one of:

generating the positioning assistance data while taking the information about the UL/DL subframe configuration into account; and

sending the positioning assistance data to the wireless device.

There is also provided a network node configured to perform the method according to the method in the network node directly above.

In FIG. 8, an exemplifying, schematic flowchart of the embodiments of the method in the wireless device 120 is shown. As mentioned, the wireless device 120 performs a method for performing a positioning measurement in a wireless communication network 100 comprising a first radio network node 110 and a second radio network node 111 neighboring to the first radio network node 110, which is serving the wireless device 120.

As mentioned, the UL/DL subframe configuration information may comprise any one or more of:

one or more complete UL/DL subframe configurations of one or more neighboring cells,

a common set of DL subframes in one or more cells, wherein the common set may comprise subframes that are downlink subframes in different UL/DL configurations of different cells or in different UL/DL configurations of a cell,

an indication of whether two or more different UL/DL configurations are used in one or more cells and a UL/DL configuration is received from a positioning node 130,

an update time interval of an UL/DL subframe configuration,

a current UL/DL subframe configuration used by the second radio network node 111, and

an indication indicating a switching point of at least one UL/DL configuration.

The following actions may be performed in any suitable order.

### State 800

In this state, the wireless device 120 may not have any, or very limited, information about UL/DL subframe configuration in e.g. a cell neighboring to a cell in which the wireless device 120 may be located. Should a positioning measurement, be performed, the wireless device may make bogus measurements, since it is not assured that there are e.g. PRS available, from the first and/or second radio network node, to measure on.

### Action 801

The wireless device 120 may send, to the first radio network node 110, a request for the UL/DL subframe configuration information relating to the second radio network node 111. This action is similar to action 607.

### Action 802

The wireless device 120 obtains UL/DL subframe configuration information relating to the second radio network node 111. This action is similar to action 608.

The obtaining of the UL/DL subframe configuration information may comprise receiving the UL/DL subframe configuration information from the first radio network node 110.

The obtaining of the UL/DL subframe configuration information may comprise receiving the UL/DL subframe configuration information from a positioning node 130.

The obtaining of the UL/DL subframe configuration information relating to the second radio network node 111 may comprise determining the UL/DL subframe configuration information based on a pre-defined rule. The UL/DL subframe configuration information may be different from the UL/DL subframe configuration information relating to the first radio network node 110.

The obtaining of the UL/DL subframe configuration information relating to the second radio network node 111 may comprise determining a non-ambiguous set of downlink subframes, and the performing 610 of the positioning measurement further comprises performing the positioning measurement in the determined non-ambiguous set of downlink subframes.

### Action 803

The wireless device 120 may receive positioning assistance data from the positioning node. This action is similar to action 609.

### Action 804

The wireless device 120 performs the positioning measurement while taking the obtained UL/DL subframe configuration information into account. This action is similar to action 610.

### State 805

At this stage, the wireless device 120 may have successfully performed the positioning measurement while it has been assured that the wireless device 120 will receive e.g. PRS from the first or second radio network nodes.

With reference to FIG. 9, a schematic block diagram of the wireless device 120 is shown. The wireless device 120 is configured to perform the methods according to embodiments herein, such as solution 1-4.

Accordingly, the wireless device 120 is configured to perform a positioning measurement in a wireless communication network 100 comprising a first radio network node 110 and a second radio network node 111 neighboring to the first radio network node 110, which is serving the wireless device 120.

The user equipment 120 comprises a processing circuit 910 configured to perform the methods according to embodiments herein, such as solution 1-4.

In particular, the processing circuit 910 is configured to obtain UL/DL subframe configuration information relating to the second radio network node 111, and to perform the positioning measurement while taking the obtained UL/DL subframe configuration into account. In some examples, the processing circuit 910 may comprise an obtaining unit configured to obtain UL/DL subframe configuration information as described in this paragraph for the processing circuit 910.

The processing circuit 910 may further be configured to receive the UL/DL subframe configuration information from the first radio network node 110.

The processing circuit 910 may further be configured to receive the UL/DL subframe configuration information from a positioning node 130.

The processing circuit 910 may further be configured to send, to the first radio network node 110, a request for the information about UL/DL subframe configuration of the second radio network node 111.

The processing circuit 910 may further be configured to obtain the UL/DL subframe configuration information relating to the second radio network node 111 by determining the UL/DL subframe configuration information based on a pre-defined rule. The obtaining unit mentioned above, or a further obtaining unit, may be configured to obtain the UL/DL subframe configuration information as described in this paragraph.

The processing circuit 910 may further be configured to determine a non-ambiguous set of downlink subframes, and to perform the positioning measurement in the determined non-ambiguous set of downlink subframes. In some examples, the processing circuit 910 may comprise a determining unit configured to determine a non-ambiguous set of downlink subframes as described in this paragraph for the processing circuit 910. Moreover, the processing circuit 910 may comprise a performing unit configured to perform the positioning measurements as described in this paragraph.

As mentioned, the UL/DL subframe configuration information may comprise any one or more of:

one or more complete UL/DL subframe configurations of one or more neighboring cells,

a common set of DL subframes in one or more cells, wherein the common set may comprise subframes that are downlink subframes in different UL/DL configurations of different cells or in different UL/DL configurations of a cell,

an indication of whether two or more different UL/DL configurations are used in one or more cells and the UL/DL configuration is received from a positioning node 130,

update time interval of the UL/DL subframe configuration,

current UL/DL subframe configuration used by the second radio network node 111, and

an indication indicating a switching point of at least one UL/DL configuration.

The wireless device 120 further comprises a transmitter 920, which may be configured to send one or more of the numbers, values or parameters described herein. As an example, the transmitter 920, such as a transmitting unit, may be configured to send, to the first radio network node 110, the request for the information about UL/DL subframe configuration of the second radio network node 111.

The wireless device 120 further comprises a receiver 930, which may be configured to receive one or more of the numbers, values or parameters described herein. As an example, the receiver 930, such as a receiving unit, may be configured to receive the UL/DL subframe configuration information from the first radio network node 110, the positioning node 130 or the like.

The wireless device 120 further comprises a memory 940 for storing software to be executed by, for example, the processing circuit. The software may comprise instructions to enable the processing circuit to perform the method in the wireless device 120 as described above.

In some examples, the wireless device 120 may comprise a processing unit 950, which may comprise one or more of the processing circuit 910, the transmitter 920, the receiver 930 and the memory 940.

In some embodiments, a computer program for performing a positioning measurement in a wireless communication network is provided. The computer program comprises computer readable code units which when executed on a computer, such as the wireless device 120, causes the computer to perform the method according to FIG. 8.

Furthermore, in some embodiments a computer program product for performing a positioning measurement in a wireless communication network is provided. The computer program product may comprise computer readable medium and the directly above mentioned computer program stored on the computer readable medium.

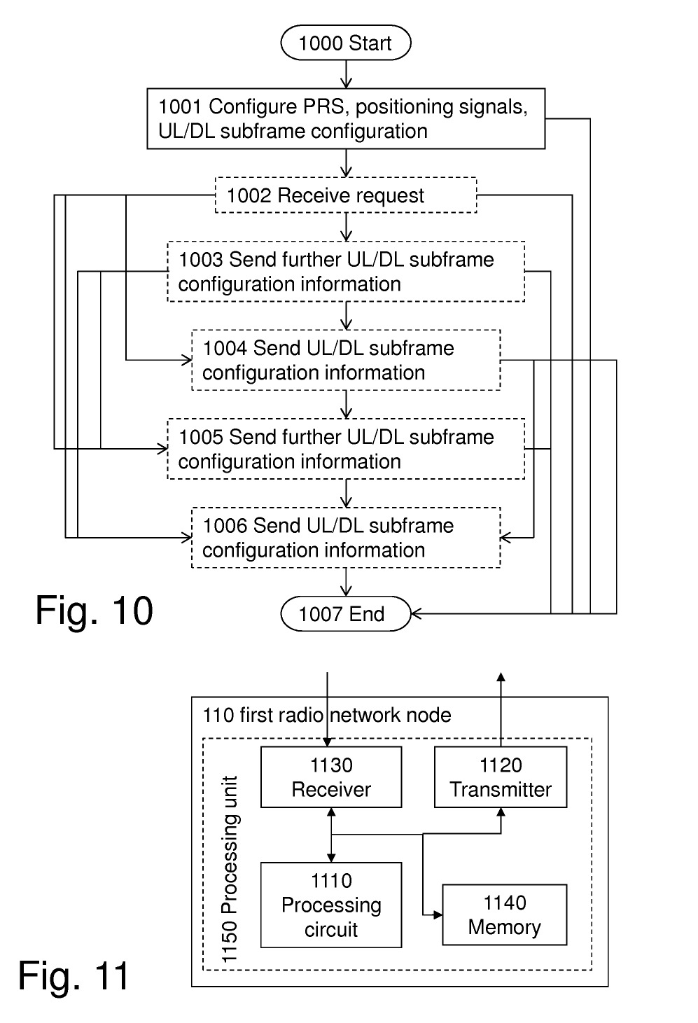

In FIG. 10, an exemplifying, schematic flowchart of the embodiments of the method in the first radio network node 110 is shown. As mentioned, the first radio network node 110 performs a method for configuring positioning reference signals, positioning subframes and/or an UL/DL subframe configuration, wherein the first radio network node 110 uses multiple UL/DL subframe configurations in a cell of the first radio network node 110.

The following actions may be performed in any suitable order.

### State 1000

In this state, first radio network node 110 may have configured a default, or predefined, UL/DL subframe configuration for its transmissions.

### Action 1001

The first radio network node 110 configures positioning reference signals, positioning subframes and/or the UL/DL subframe configuration in a non-ambiguous set of downlink subframes. This action is similar to action 601.

The non-ambiguous set of downlink subframes may comprise a number of flexible subframes, wherein the number of flexible subframes is less than a threshold value.

The configuring of the positioning reference signals, PRS, the positioning signals and/or positioning subframes may comprise configuring number of positioning subframes and PRS configuration index to maximize number of downlink subframes until an upcoming special subframe.

### Action 1002

The first radio network node 110 may receive a request from the wireless device 120. This action is similar to action 602.

### Action 1003

The first radio network node 110 may send further UL/DL subframe configuration information or a configuration comprising the non-ambiguous set of downlink subframes to the wireless device 120 for purpose of positioning, wherein the further UL/DL subframe configuration information relates to a second radio network node 111 neighboring to the first radio network node 110. This action is similar to action 603.

### Action 1004

The first radio network node 110 may send at least one UL/DL subframe configuration information of the multiple UL/DL subframe configurations or a configuration comprising the non-ambiguous set of downlink subframes to a positioning node 130. This action is similar to action 604.

### Action 1005

The first radio network node 110 may send further UL/DL subframe configuration information to a positioning node 130, wherein the further UL/DL subframe configuration information relates to a second radio network node 111 neighboring to the first radio network node 110. This action is similar to action 605.

### Action 1006

The first radio network node 110 may send at least one UL/DL subframe configuration information for the multiple UL/DL subframe configurations to another network node for purpose of positioning. This action is similar to action 606.

### State 1007

At this stage, the first radio network node 110 may have allowed various other nodes, such as the positioning node and the second radio network node, to become aware of its, or its neighbours, UL/DL subframe configuration. Once, a change of the UL/DL subframe configuration may occur, the first radio network node may again execute the actions above, e.g. starting with action 1001.

With reference to FIG. 11, a schematic block diagram of the first radio network node 110 is shown. The first radio network node 110 is configured to perform the methods according to embodiments herein, such as solution 1-4. In the description above, the second and/or third node may be an SLP.

Accordingly, the first radio network node 110 is configured to configure positioning reference signals, positioning subframes and/or an UL/DL subframe configuration. The first radio network node 110 uses multiple UL/DL subframe configurations in a cell of the first radio network node 110.

In some embodiments, the first radio network node 110 may be the radio network node 110.

The first radio network node 110 comprises a processing circuit 1110 configured to perform the methods according to embodiments herein, such as solution 1-4.

In particular, the processing circuit 1110 is configured to configure positioning reference signals, positioning subframes and/or UL/DL subframe configuration in a non-ambiguous set of subframes. As an example, the processing circuit may comprise a configuring unit configured as the processing circuit 1110 as described in this paragraph.

The non-ambiguous set of downlink subframes may comprise a number of flexible subframes. The number of flexible subframes is less than a threshold value.

The processing circuit 1110 may further be configured to configure number of positioning subframes and PRS configuration index to maximize number of downlink subframes until an upcoming special subframe. The configuring unit, or a further configuring unit, may be configured as the processing circuit 1110 as described in this paragraph.

The processing circuit 1110 may further be configured to send further UL/DL subframe configuration information or a configuration comprising the non-ambiguous set of downlink subframes to the wireless device 120 for purpose of positioning. The further UL/DL subframe configuration information relates to a second radio network node 111 neighbouring to the first radio network node 110.

The processing circuit 1110 may further be configured to send at least one UL/DL subframe configuration information of the multiple UL/DL subframe configurations or a configuration comprising the non-ambiguous set of downlink subframes to a positioning node 130.

The processing circuit 1110 may further be configured to send further UL/DL subframe configuration information to a positioning node 130. The further UL/DL subframe configuration information relates to a second radio network node 111 neighbouring to the first radio network node 110.

The processing circuit 1110 may further be configured to send at least one UL/DL subframe configuration information for the multiple UL/DL subframe configurations to another network node for purpose of positioning.

The first radio network node 110 further comprises a transmitter 1120, which may be configured to send one or more of the numbers, values or parameters described herein. As an example, the transmitter 1120, such as a transmitting unit, may be configured to send further UL/DL subframe configuration information or a configuration comprising the non-ambiguous set of downlink subframes to the wireless device 120 for purpose of positioning; to send at least one UL/DL subframe configuration information of the multiple UL/DL subframe configurations or a configuration comprising the non-ambiguous set of downlink subframes to a positioning node 130; to send further UL/DL subframe configuration information to a positioning node 130; and/or to send at least one UL/DL subframe configuration information for the multiple UL/DL subframe configurations to another network node for purpose of positioning.

The first radio network node 110 further comprises a receiver 1130, which may be configured to receive one or more of the numbers, values or parameters described herein. As an example, the receiver 1130, such as a receiving unit, may be configured to receive the request for the UL/DL subframe configuration information relating to the second radio network node 111.

The first radio network node 110 further comprises a memory 1140 for storing software to be executed by, for example, the processing circuit. The software may comprise instructions to enable the processing circuit to perform the method in the first radio network node 110 as described above.

In some examples, the first radio network node 110 may comprise a processing unit 1150, which may comprise one or more of the processing circuit 1110, the transmitter 1120, the receiver 1130 and the memory 1140.

In some embodiments, a computer program for configuring positioning reference signals, positioning subframes and/or UL/DL subframe configuration is provided. The computer program comprises computer readable code units which when executed on a computer, such as the first radio network node 110, causes the computer to perform the method according to FIG. 10.

Furthermore, in some embodiments a computer program product for configuring positioning reference signals, positioning subframes and/or UL/DL subframe configuration is provided. The computer program product may comprise computer readable medium and the directly above mentioned computer program stored on the computer readable medium.

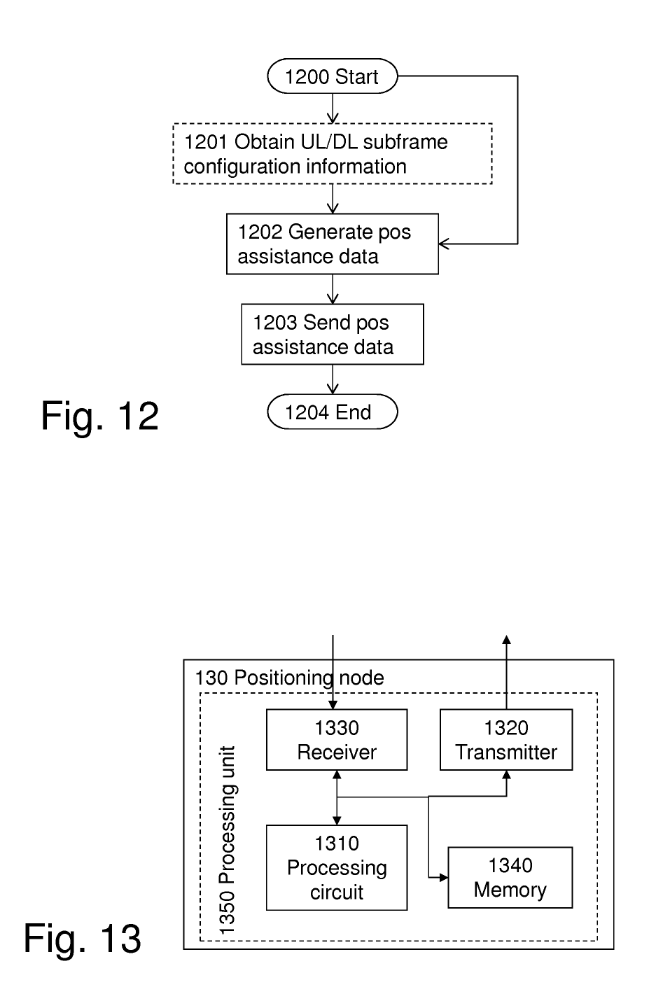

In FIG. 12, an exemplifying, schematic flowchart of the embodiments of the method in the positioning node 130 is shown. As mentioned, the positioning node 130 performs a method for building positioning assistance data to be used by a wireless device 120 when performing positioning measurements on a set of radio network nodes 110, 111, wherein each radio network node 110, 111 of the set of radio network nodes 110, 111 is associated with a respective UL/DL subframe configuration information, wherein at least one respective UL/DL subframe configuration information is different from at least one other respective UL/DL subframe configuration information.

The following actions may be performed in any suitable order.

### State 1200

In this state, the positioning node 130 may initially have been assigned a predefined, or default, positioning assistance data. In the following method, the positioning assistance data may be adapted to varying UL/DL subframe configurations of node, such as the first and second radio network node, in the wireless communication network 100.

### Action 1201

The positioning node 130 may obtain the respective UL/DL subframe configuration information by one or more of:
receiving the respective UL/DL subframe configuration information from at least one of the radio network nodes 110, 111 of the set of radio network nodes 110, 111;
receiving the respective UL/DL subframe configuration information from another node;
retrieving the respective UL/DL subframe configuration information from a database; and
retrieving the respective UL/DL subframe configuration information from cell data.
   This action is similar to action 611.

### Action 1202

The positioning node 130 generates the positioning assistance data while taking at least one respective UL/DL subframe configuration information into account, thereby building the positioning assistance data. This action is similar to action 612.

The generating 612 of the positioning assistance data may comprise one or more of:

selecting a positioning method to be included in the positioning assistance data;

selecting radio nodes whose radio signals are to be measured by the wireless device 120, wherein information related to said radio nodes is to be included in the positioning assistance data;

selecting a reference cell to have information about selected reference cell included in the positioning assistance data; and

modifying a positioning subframe configuration included in the positioning assistance data.

### Action 1203

The positioning node 130 sends the positioning assistance data to the wireless device 120. This action is similar to action 613.

### State 1204

The positioning node may now again return to action 1201 to receive new UL/DL subframe configuration information which may need to be processed as described above.

With reference to FIG. 13, a schematic block diagram of the positioning node 130, such as a positioning server, is shown. The positioning node 130 is configured to perform the methods according to embodiments herein, such as solution 1-4. In the description above, the positioning node 130 is referred to as the second and/or third node.

Accordingly, the positioning node 130 is configured to build positioning assistance data to be used by a wireless device 120 when performing positioning measurements on a set of radio network nodes 110, 111. Each radio network node 110, 111 of the set of radio network node 110, 111 is associated with a respective UL/DL subframe configuration information. At least one respective UL/DL subframe configuration information is different from at least one other respective UL/DL subframe configuration.

The positioning node 130 comprises a processing circuit 1310 configured to perform the methods according to embodiments herein, such as solution 1-4.

In particular, the processing circuit 1310 is configured to generate the positioning assistance data while taking at least one respective UL/DL subframe configuration information into account, thereby building the positioning assistance data, and to send the positioning assistance data to the wireless device 120. As an example, the processing circuit 1310 may comprise a generating unit configured to generate the positioning assistance data as described in this paragraph.

The processing circuit 1310 may further be configured to one or more of:

select a positioning method to be included in the positioning assistance data;

select radio nodes whose radio signals are to be measured by the wireless device 120, wherein information related to said radio nodes is to be included in the positioning assistance data;

select a reference cell to have information about selected reference cell included in the positioning assistance data; and

modify positioning subframe configuration included in the positioning assistance data.

The processing circuit 1310 may further be configured to one or more of:

receive the respective UL/DL subframe configuration information from at least one of the radio network nodes 110, 111 of the set of radio network nodes 110, 111;

receive the respective UL/DL subframe configuration information from another node;

retrieve the respective UL/DL subframe configuration information from a database; and

retrieve the respective UL/DL subframe configuration information from cell data.

Consequently, according to various embodiments as described directly above, the processing circuit 1310 may comprise a selecting unit, a modifying unit, a retrieving unit and the like.

The positioning node 130 further comprises a transmitter 1320, which may be configured to send one or more of the numbers, values or parameters described herein. As an example, the transmitter 1320, such as a transmitting unit, may be configured to send the positioning assistance data to the wireless device 120.

The positioning node 130 further comprises a receiver 1330, which may be configured to receive one or more of the numbers, values or parameters described herein. As an example, the receiver 1330, such as a receiving unit, may be configured to receive UL/DL subframe configuration information from the first radio network node 110.

The positioning node 130 further comprises a memory 1340 for storing software to be executed by, for example, the processing circuit. The software may comprise instructions to enable the processing circuit to perform the method in the positioning node 130 as described above.

In some examples, the positioning node 130 may comprise a processing unit 1350, which may comprise one or more of the processing circuit 1310, the transmitter 1320, the receiver 1330 and the memory 1340.

In some embodiments, a computer program for generating the positioning assistance data while taking at least one respective UL/DL subframe configuration information into account is provided. The computer program comprises computer readable code units which when executed on a computer, such as the positioning node 130, causes the computer to perform the method according to FIG. 12.

Furthermore, in some embodiments a computer program product for generating the positioning assistance data while taking at least one respective UL/DL subframe configuration information into account is provided. The computer program product may comprise computer readable medium and the directly above mentioned computer program stored on the computer readable medium.

As used herein, the term “processing circuit” may relate to a processing unit, a processor, an application specific integrated circuit (ASIC), a field-programmable gate array (FPGA) or the like. As an example, a processor, an ASIC, an FPGA or the like may comprise one or more processor kernels. In some examples, the processing circuit may be embodied by a software and/or hardware module. Any such module may be a determining means, estimating means, capturing means, associating means, comparing means, identification means, selecting means, receiving means, transmitting means or the like as disclosed herein. As an example, the expression “means” may be a unit, such as a determining unit, selecting unit, etc.

As used herein, the term “memory” may refer to a hard disk, a magnetic storage medium, a portable computer diskette or disc, flash memory, random access memory (RAM) or the like. Furthermore, the memory may be an internal register memory of a processor.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

Even though embodiments of the various aspects have been described, many different alterations, modifications and the like thereof will become apparent for those skilled in the art. The described embodiments are therefore not intended to limit the scope of the present disclosure.

1. A method, performed by a wireless device, for performing a positioning measurement in a wireless communication network comprising a first radio network node and a second radio network node neighboring to the first radio network node, which is serving the wireless device, wherein the method comprises:
obtaining uplink/downlink, “UL/DL”, subframe configuration information relating to the second radio network node, and
performing the positioning measurement while taking the obtained UL/DL subframe configuration information into account.

2. The method according to claim 1, wherein the obtaining of the UL/DL subframe configuration information comprises receiving the UL/DL subframe configuration information from the first radio network node.

3. The method according to claim 1, wherein the obtaining of the UL/DL subframe configuration information comprises receiving the UL/DL subframe configuration information from a positioning node.

4. The method according to claim 1, wherein the UL/DL subframe configuration information comprises any one or more of:
one or more complete UL/DL subframe configurations of one or more neighboring cells,
a common set of DL subframes in one or more cells, wherein the common set comprises subframes that are downlink subframes in different UL/DL configurations of different cells or in different UL/DL configurations of a cell,
an indication of whether two or more different UL/DL configurations are used in one or more cells and a UL/DL configuration is received from a positioning node,
an update time interval of an UL/DL subframe configuration,
a current UL/DL subframe configuration used by the second radio network node, and
an indication indicating a switching point of at least one UL/DL configuration.

5. The method according to claim 1, wherein the method further comprises:
sending, to the first radio network node, a request for the UL/DL subframe configuration information relating to the second radio network node.

6. The method according to claim 1, wherein the obtaining of the UL/DL subframe configuration information relating to the second radio network node comprises determining the UL/DL subframe configuration information based on a pre-defined rule, and wherein the UL/DL subframe configuration information is different from the UL/DL subframe configuration information relating to the first radio network node.

7. The method according to claim 1, wherein the obtaining of the UL/DL subframe configuration information relating to the second radio network node comprises determining a non-ambiguous set of downlink subframes, and the performing of the positioning measurement further comprises performing the positioning measurement in the determined non-ambiguous set of downlink subframes.

8. A method, performed by a first radio network node, for configuring positioning reference signals, positioning subframes and/or an uplink/downlink, “UL/DL”, subframe configuration, wherein the first radio network node uses multiple UL/DL subframe configurations in a cell of the first radio network node, wherein the method comprises:
configuring positioning reference signals, positioning subframes and/or the UL/DL subframe configuration in a non-ambiguous set of downlink subframes.

9. The method according to claim 8, wherein the non-ambiguous set of downlink subframes comprises a number of flexible subframes, wherein the number of flexible subframes is less than a threshold value.

10. The method according to claim 8, wherein the configuring of the positioning reference signals, PRS, the positioning signals and/or positioning subframes comprises configuring number of positioning subframes and PRS configuration index to maximize number of downlink subframes until an upcoming special subframe.

11. The method according to claim 8, wherein the method comprises:
sending at least one UL/DL subframe configuration information of the multiple UL/DL subframe configurations or a configuration comprising the non-ambiguous set of downlink subframes to a positioning node.

12. The method according to claim 8, wherein the method comprises:
sending further UL/DL subframe configuration information or a configuration comprising the non-ambiguous set of downlink subframes to the wireless device for purpose of positioning, wherein the further UL/DL subframe configuration information relates to a second radio network node neighboring to the first radio network node.

13. The method according to claim 8, wherein the method comprises:
sending further UL/DL subframe configuration information to a positioning node, wherein the further UL/DL subframe configuration information relates to a second radio network node neighboring to the first radio network node.

14. The method according to claim 8, wherein the method comprises:
sending at least one UL/DL subframe configuration information for the multiple UL/DL subframe configurations to another network node for purpose of positioning.

15. A method, performed by a positioning node for building positioning assistance data to be used by a wireless device when performing positioning measurements on a set of radio network nodes, wherein each radio network node of the set of radio network nodes is associated with a respective uplink/downlink, “UL/DL”, subframe configuration information, wherein at least one respective UL/DL subframe configuration information is different from at least one other respective UL/DL subframe configuration information, wherein the method comprises:
generating the positioning assistance data while taking at least one respective UL/DL subframe configuration information into account, thereby building the positioning assistance data; and
sending the positioning assistance data to the wireless device.

16. The method according to claim 15, wherein the generating of the positioning assistance data comprises one or more of:
selecting a positioning method to be included in the positioning assistance data;
selecting radio nodes whose radio signals are to be measured by the wireless device, wherein information related to said radio nodes is to be included in the positioning assistance data;
selecting a reference cell to have information about selected reference cell included in the positioning assistance data; and
modifying a positioning subframe configuration included in the positioning assistance data.

17. The method according to claim 15, wherein the method further comprises:
obtaining the respective UL/DL subframe configuration information by one or more of:
receiving the respective UL/DL subframe configuration information from at least one of the radio network nodes of the set of radio network nodes;
receiving the respective UL/DL subframe configuration information from another node;
retrieving the respective UL/DL subframe configuration information from a database; and
retrieving the respective UL/DL subframe configuration information from cell data.

18. A wireless device configured to perform a positioning measurement in a wireless communication network comprising a first radio network node and a second radio network node neighboring to the first radio network node, which is serving the wireless device, wherein the wireless device comprises a processing circuit configured to:
obtain uplink/downlink, “UL/DL”, subframe configuration information relating to the second radio network node, and
perform the positioning measurement while taking the obtained UL/DL subframe configuration into account.

19. The wireless device according to claim 18, wherein the processing circuit further is configured to receive the UL/DL subframe configuration information from the first radio network node.

20. The wireless device according to claim 18, wherein the processing circuit further is configured to receive the UL/DL subframe configuration information from a positioning node.

21. The wireless device according to claim 18, wherein the UL/DL subframe configuration information comprises any one or more of:
one or more complete UL/DL subframe configurations of one or more neighboring cells,
a common set of DL subframes in one or more cells, wherein the common set comprises subframes that are downlink subframes in different UL/DL configurations of different cells or in different UL/DL configurations of a cell,
an indication of whether two or more different UL/DL configurations are used in one or more cells and the UL/DL configuration is received from a positioning node,
update time interval of the UL/DL subframe configuration,
current UL/DL subframe configuration used by the second radio network node, and
an indication indicating a switching point of at least one UL/DL configuration.

22. The wireless device according to claim 18, wherein the processing circuit further is configured to send, to the first radio network node, a request for the information about UL/DL subframe configuration of the second radio network node.

23. The wireless device according to claim 18, wherein the processing circuit further is configured to obtain the UL/DL subframe configuration information relating to the second radio network node by determining the UL/DL subframe configuration information based on a pre-defined rule, and wherein the UL/DL subframe configuration information is different from the UL/DL subframe configuration information relating to the first radio network node.

24. The wireless device according to claim 18, wherein the processing circuit further is configured to determine a non-ambiguous set of downlink subframes, and to perform the positioning measurement in the determined non-ambiguous set of downlink subframes.

25. A first radio network node configured to configure positioning reference signals, positioning subframes and/or an uplink/downlink, “UL/DL”, subframe configuration, wherein the first radio network node uses multiple UL/DL subframe configurations in a cell of the first radio network node, wherein the first radio network node comprises a processing circuit configured to configure positioning reference signals, positioning subframes and/or UL/DL subframe configuration in a non-ambiguous set of subframes.

26. The first radio network node according to claim 25, wherein the non-ambiguous set of downlink subframes comprises a number of flexible subframes, wherein the number of flexible subframes is less than a threshold value.

27. The first radio network node according to claim 25, wherein the processing circuit further is configured to configure number of positioning subframes and PRS configuration index to maximize number of downlink subframes until an upcoming special subframe.

28. The first radio network node according to claim 25, wherein the processing circuit further is configured to send further UL/DL subframe configuration information or a configuration comprising the non-ambiguous set of downlink subframes to the wireless device for purpose of positioning, wherein the further UL/DL subframe configuration information relates to a second radio network node neighboring to the first radio network node.

29. The first radio network node according to claim 25, wherein the processing circuit further is configured to send at least one UL/DL subframe configuration information for the multiple UL/DL subframe configurations or a configuration comprising the non-ambiguous set of downlink subframes to a positioning node.

30. The first radio network node according to claim 25, wherein the processing circuit further is configured to send further UL/DL subframe configuration information to a positioning node, wherein the further UL/DL subframe configuration information relates to a second radio network node neighboring to the first radio network node.

31. The first radio network node according to claim 25, wherein the processing circuit further is configured to send at least one UL/DL subframe configuration information for the multiple UL/DL subframe configurations to another network node for purpose of positioning.

32. A positioning node configured to build positioning assistance data to be used by a wireless device when performing positioning measurements on a set of radio network nodes, wherein each radio network node of the set of radio network node is associated with a respective uplink/downlink, “UL/DL”, subframe configuration information, wherein at least one respective UL/DL subframe configuration information is different from at least one other respective UL/DL subframe configuration information, wherein the positioning node comprises a processing circuit configured to:
generate the positioning assistance data while taking at least one respective UL/DL subframe configuration information into account, thereby building the positioning assistance data; and
send the positioning assistance data to the wireless device.

33. The positioning node according to claim 32, wherein the processing circuit further is configured to one or more of:
select a positioning method to be included in the positioning assistance data;
select radio nodes whose radio signals are to be measured by the wireless device, wherein information related to said radio nodes is to be included in the positioning assistance data;
select a reference cell to have information about selected reference cell included in the positioning assistance data; and
modify positioning subframe configuration included in the positioning assistance data.

34. The positioning node according to claim 32, wherein the processing circuit further is configured to one or more of:
receive the respective UL/DL subframe configuration information from at least one of the radio network nodes of the set of radio network nodes;
receive the respective UL/DL subframe configuration information from another node;
retrieve the respective UL/DL subframe configuration information from a database; and
retrieve the respective UL/DL subframe configuration information from cell data.
